(19) United States
(12) Patent Application Publication
(10) Pub. No.: US 2026/0180933 A1
(43) Pub. Date: Jun. 25, 2026

(54) AUTOMATIC PERSONALIZED RESPONSE GENERATION FOR AN EMAIL USING INTEGRATED PROGRAMMATIC AND SPECIALIZED GUIDED AND CONSTRAINED ARTIFICIAL INTELLIGENCE

(71) Applicant: IGNITE ENTERPRISE SOFTWARE SOLUTIONS, LLC, Austin, TX (US)

(72) Inventors: Douglas Ho, Kuala Lumpur (MY); Eric Vaughan, Galveston, TX (US); Thibault Bridel-Bertomeu, Bassins (CH)

(73) Assignee: IGNITE ENTERPRISE SOFTWARE SOLUTIONS, LLC, Austin, TX (US)

(21) Appl. No.: 19/431,641

(22) Filed: Dec. 23, 2025

Related U.S. Application Data
(60) Provisional application No. 63/738,421, filed on Dec. 23, 2024.

(51) Int. Cl. H04L 51/02; G06F 40/58; G06Q 10/107; H04L 51/21

(52) U.S. Cl. CPC H04L 51/02; G06F 40/58; G06Q 10/107; H04L 51/21

(57) ABSTRACT

An automatic personalized response generation system and process receives user email containing questions and knowledge base articles through an email receiver integrated to an email engine and stores the user emails in a knowledge database. A gatekeeper module classifies incoming emails using structured criteria. A knowledge module gathers and organizes relevant information from the knowledge database and the gatekeeper module. An orchestrator module then routes the classified emails and relevant information to either a responder module or a human agent. The responder module crafts personalized responses, which are then refined by a modify module according to specific quality criteria. Throughout the personalized response generation process, the gatekeeper module, the knowledge module, the orchestrator module, the responder module, and the modify module utilize specialized prompts to guide an Artificial Intelligence (AI) engine via a prompt generator in performing its designated tasks. The email engine transmits the modified personalized responses back to user.

### CROSS-REFERENCE TO RELATED APPLICATION(S)

This application claims the benefit under 35 U.S.C. § 119(e) and 37 C.F.R. § 1.78 of U.S. Provisional Application No. 63/738,421, which is incorporated by reference in its entirety.

### FIELD OF THE INVENTION

The present invention relates in general to the field of electronics and more specifically to a system and method for an automatic personalized response generation for a user email by guiding the artificial intelligence (AI) engine with a plurality of prompts.

### DESCRIPTION OF THE RELATED ART

Email communication has become a critical channel for customer service, with organizations worldwide processing millions of customer (user) inquiries daily through their support channels. As user email volumes grow exponentially, organizations face mounting pressure to efficiently manage the communications while maintaining response quality and customer satisfaction. The evolution of email response management has progressed through different approaches. Each approach presents its own set of challenges and limitations in addressing the fundamental need for efficient, accurate, and personalized customer communication.

A manual process requires human agents to read each user email, understand the context, search for relevant information, craft an appropriate response, and ensure accuracy before sending. The human agents often handle hundreds of emails daily, leading to response delays, inconsistent messaging, and increased operational costs. Organizations maintain large human agents' teams to manage the user email volume yet still struggle with backlogs and delayed response times. The time-intensive nature of the manual process prevents human agents from focusing on complex customer issues that require the human agent expertise and judgment. Furthermore, during peak periods or staff shortages, the manual process approach creates bottlenecks that negatively impact customer satisfaction and retention rates.

An email template approach to streamline the user communication process and standardize responses. Wherein human agents select pre-written templates from a repository, customize specific fields with customer information, and send standardized replies to common inquiries. While the email templates reduce response time compared to a fully manual process, the human agents still face challenges in email template management and customization. The human agent must locate the appropriate template among dozens or hundreds of options, modify the content to match the specific user situation, and ensure all placeholder fields contain accurate information. The email template approach, though faster than fully manual responses, creates new inefficiencies as teams spend time maintaining template libraries, updating outdated content, and training the human agents on proper template usage. Additionally, users often recognize templated responses, which can feel impersonal and fail to address the nuanced aspects of their specific inquiries.

Semi-automated email response systems combine human agent oversight with automated technologies to process customer inquiries. The semi-automated email response systems employ basic rules and keyword matching to suggest relevant responses, which human agents then review, modify, and approve before sending to customers. The semi-automated email response systems analyze incoming messages, categorize them by topic, and present for human agents. The semi-automated email response systems reduce some human agent effort, but the human agents still dedicate considerable time to reviewing suggestions, making necessary adjustments, and ensuring the final response accurately addresses customer needs. The limitations of rule-based matching often result in inappropriate suggestions that require substantial human agent modification, diminishing the potential efficiency gains. Furthermore, the semi-automated email response systems struggle with complex or unique inquiries where historical patterns provide limited guidance, forcing the human agents to resort to manual composition in many cases.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary automatic personalized response generation system for a user email.

FIG. 2 depicts an exemplary automatic personalized response generation process for a user email utilized by the automatic personalized response generation system.

FIG. 3 depicts a persona-based email system with custom RAG, which is an embodiment of an automatic personalized response generation process.

FIG. 4 depicts a dynamic model selection system, which is an embodiment of an automatic personalized response generation process.

FIG. 5 depicts a live and draft mode email system, which is an embodiment of an automatic personalized response generation process.

FIG. 6 depicts a multilingual email handling system, which is an embodiment of an automatic personalized response generation process.

FIG. 7 depicts an automatic human referral system, which is an embodiment of an automatic personalized response generation process.

FIG. 8 depicts a data structure for an automatic personalized response generation process.

FIG. 9 depicts an architectural diagram of an automatic personalized response generation process utilized by the automatic personalized response generation system.

FIG. 10 depicts a process flow 1000 of an automatic personalized response generation process utilized by the automatic personalized response generation system.

FIG. 11 depicts an exemplary network environment in which the automatic personalized response generation system of FIG. 1 and the process of FIG. 2 may be practiced.

FIG. 12 depicts an exemplary computer system.

### DETAILED DESCRIPTION

An automatic personalized response generation system and process receives a user emails containing questions and knowledge base articles through an email receiver integrated to an email engine and stores the user email in a knowledge database. A gatekeeper module classifies incoming emails using structured criteria. A knowledge module gathers and organizes relevant information from the knowledge database and the gatekeeper module. An orchestrator module then routes the classified emails and relevant information to either a responder module or human agent. The responder module crafts personalized responses, which are then refined by a modify module according to specific quality criteria. Throughout the personalized response generation process, the gatekeeper module, the knowledge module, the orchestrator module, the responder module, and the modify module utilize specialized prompts to guide an Artificial Intelligence (AI) engine via a prompt generator in performing its designated tasks. The email engine transmits the modified personalized responses back to a user.

The automatic personalized response generation system offers several key advantages over past traditional email systems. The automatic personalized response generation system enables truly human-like conversations by maintaining context across entire email threads, unlike traditional email systems that generate generic template-based responses. The dynamic model selection chooses the most appropriate AI model for each interaction, eliminating the inefficiencies of static model usage and manual model selection. Moreover, the automatic personalized response generation system provides unprecedented flexibility by allowing both immediate automated responses and human oversight when needed and multilingual capabilities with automatic translation seamlessly handle cross-language communication while preserving context, improving upon basic translation plugins or costly manual translation services.

The system and method set forth herein address technical issues with generating the desired outputs described herein. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

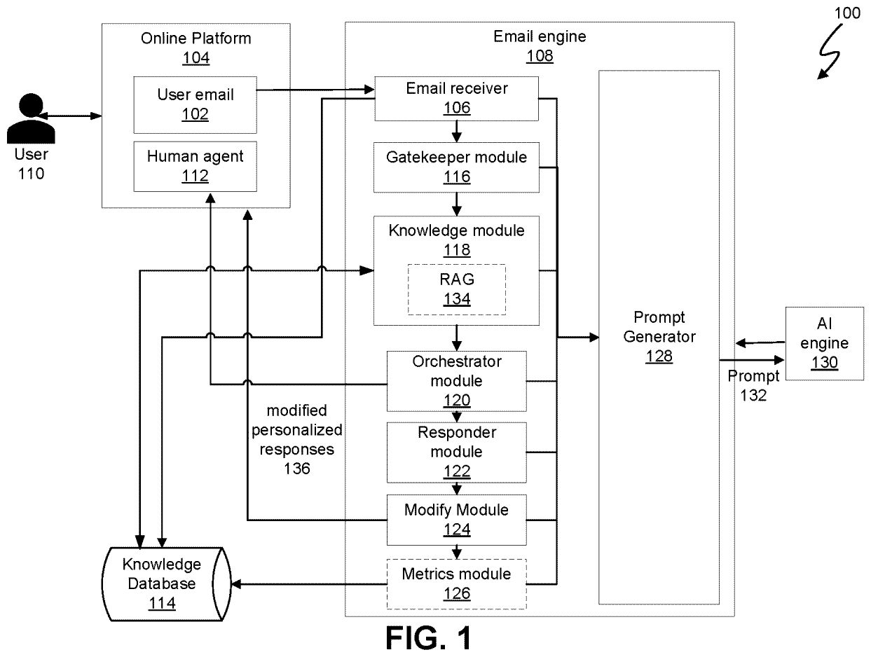

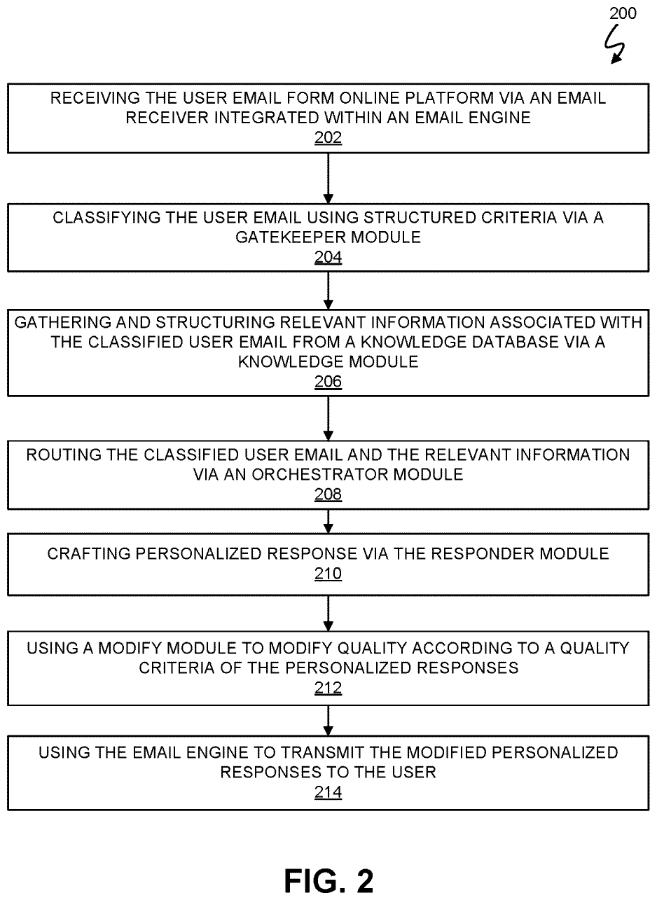

FIG. 1 depicts an exemplary automatic personalized response generation system 100 for a user email 102, and FIG. 2 depicts an exemplary automatic personalized response generation process 200 that utilizes the automatic personalized response generation system 100 100.

Referring to FIGS. 1 and 2, in operation 202, an email receiver 106 integrated within an email engine 108 receives a user email 102 from an online platform 104, wherein the user email 102 includes questions and knowledge base articles.

The online platform 104 serves as a digital infrastructure that enables the customer service providers to interact, communicate, share content, or conduct transactions over the internet. The online platform 104 includes the user email 102 and a human agent 112 module.

The online platform 104 in at least one embodiment integrates multiple technologies and services to create cohesive environments where the customer service providers can achieve their goals, whether they involve learning, marketing, or conducting business operations. The online platform 104 in at least one embodiment combines multiple layers of technology and code. The online platform 104 creates the front-end interface using programming languages like HTML, CSS, and JavaScript to design the visual elements and user 110 interactions. The online platform 104 is connected to back-end infrastructure using languages such as Python, Java, or Node.js to handle data processing and operations.

The online platform 104 in at least one embodiment, utilizes NextAuth.js for handling the authentication flow by integrating with multiple OAuth 2.0 providers such as Google, GitHub, or custom providers through a configuration file. The NextAuth.js manages the user 110 sessions and token storage while providing built-in API routes for login, logout, and session management. The NextAuth.js protects sensitive routes and automatically redirects unauthenticated user 110 to the login page, while offering hooks and callbacks for customizing the authentication behavior.

The user email 102 is a digital message that enables the user 110 to send and receive electronic communications instantly across the internet. The user 110 composes and transmits the user email 102 containing text, attachments, images, and links to customer service providers anywhere in the world using email client software or web-based services. The email client software or web-based services processes the user email 102 through email servers, which route the content from the user 110 to customer service providers using unique email addresses that contain the “@” symbol followed by a domain name. User 110 accesses the user email 102 through various devices such as computers, smartphones, or tablets, while the user email 102 providers store the user email 102 in digital mailboxes that organize incoming and outgoing correspondence.

The user email 102 includes questions and knowledge base articles. The question the user 110 sends to a customer service provider represents a specific inquiry or problem that a user 110 faces during any operations and directs to a customer service provider seeking assistance or clarification. The question typically addresses product functionality, service issues, account management, billing concerns, or technical difficulties that require expert guidance or resolution.

The knowledge base articles are the attachment to the question sent by the user 110. The knowledge base article in at least one embodiment includes the details the user 110 has taken to solve the question, the screen shots of the problem, screen recording, and any other relevant document related to the question.

The email receiver 106 is integrated with the email engine 108. The email receiver 106 retrieves the user email 102 from the online platform 104. The email receiver 106 in at least one embodiment connects directly to email service providers such as Gmail and Microsoft through their respective application programming interfaces (APIs). APIs connect different software systems and enable them to communicate with each other. APIs access specific functions or data from external services without needing to understand their internal workings. APIs establish rules and protocols that define how applications interact, allowing them to send requests and receive responses in a standardized format.

The email receiver 106 checks the online platform 104 for any user email 102 in a regular time interval. When the email receiver 106 finds new user email 102, the email receiver 106 extracts all email components, including the questions, knowledge base articles, sender, recipients, CC/BCC information, and user email 102 body content. The email receiver 106 shares the extracted information with a knowledge database 114 and a gatekeeper module 116 in real time.

The email engine 108 operates as a backend system. The email engine 108 contains multiple integrated components, such as the email receiver 106, the gatekeeper module 116, a knowledge module 118 with a retrieval-augmented generation (RAG) 134 capabilities, an orchestrator module 120, a responder module 122, a modify module 124, a metrics module 126 and a prompt generator 128. The email engine 108 coordinates the communication between the multiple integrated modules with an Artificial Intelligence (AI) engine 130, through APIs.

The email receiver 106 in at least one embodiment fetches the user 110 details from the online platform 104. The user 110 details are then stored in the knowledge database 114 for further requirements.

The email engine 108 in at least one embodiment works as a serverless application on Amazon Web Services (AWS) infrastructure. AWS provides a global cloud infrastructure that delivers computing power, storage, and networking services over the internet. AWS operates a vast network of data centers equipped with servers, databases, and virtual machines that businesses use to run their applications and store data. AWS's infrastructure is used for scaling operations, reducing costs, and accessing advanced technologies without maintaining physical hardware.

The email engine 108 in at least one embodiment monitors operations through AWS CloudWatch integration. AWS CloudWatch monitors AWS resources and applications in real-time by collecting and tracking metrics, logs, and events. AWS CloudWatch enables users to set alarms that automatically respond to changes in AWS resources, sending notifications or taking corrective actions when thresholds are breached. AWS CloudWatch provides detailed operational visibility through customizable dashboards, helping the customer service providers detect anomalies, troubleshoot issues, and optimize resource utilization across their AWS infrastructure.

In operation 204, the gatekeeper module 116 classifies the user email 102 using structured criteria, wherein the gatekeeper module 116 utilizes a gatekeeper prompt for guiding the AI engine 130 to classify user email 102.

The gatekeeper module 116 serves as the first point of analysis when the user email 102 enters the email engine 108. The gatekeeper module 116 processes incoming user email 102 through a structured evaluation framework guided by the gatekeeper prompt provided to the AI engine 130. When the user email 102 arrives, the gatekeeper module 116 analyzes the user email 102 type, categorizing the user email 102 as either human-generated, automated, or system-generated content. The gatekeeper module 116 looks for key indicators such as message format, headers, and content patterns to make this determination.

The gatekeeper module 116 then checks specific response criteria, such as new, ongoing, or closed, by verifying recipient matching and examining the user email 102. The gatekeeper module 116 in at least one embodiment checks for any custom business rules that have been defined by the user 110. The gatekeeper module 116 conducts a priority assessment. The gatekeeper module 116 evaluates the urgency level of the user email 102, such as high, medium, or low, determines its potential business impact, such as critical, standard, or minimal, and assigns appropriate response timing requirements.

When the gatekeeper module 116 identifies the user email 102 as automated by matching these patterns, the gatekeeper module 116 immediately classifies it in the automated message category with high confidence during the classification.

The automated classification triggers the application of No-Response Criteria rules, causing the gatekeeper module 116 to output a no response decision with a high confidence score, which leads to automatic archiving of the user email 102 without further processing.

The AI engine 130 processes all the classification by the gatekeeper module 116 through the gatekeeper prompt. The AI engine 130 acts as the core computational system that processes and generates responses using artificial intelligence models such as GPT-40 and Claude 3.5. The AI engine 130 accepts prompt 132 (gatekeeper prompt) and input data from the email engine 108, processes them through sophisticated language understanding algorithms, and returns contextually appropriate output responses.

The schema of the gatekeeper prompt that provides engineered, specialized and guidance and constraint to the AI engine 130 is:

```
  <role> You are the primary filter for the Eloquens email response
system. Your role is to evaluate incoming emails using structured
criteria to determine appropriate handling of a ‘respond’ or
‘no_response’. </role>
  <evaluation process>
  1. Message Type Analysis:
  - Identify message category [HUMAN|AUTOMATED|SYSTEM]
  - Detect key indicators [URGENT|ROUTINE|NOTIFICATION]
  - Assess sender type [INTERNAL|CUSTOMER|UNKNOWN]
  2. Response Criteria Check:
  - Verify recipient matching [{name}|{email}]
  - Check conversation context [NEW|ONGOING|CLOSED]
  - Apply business rules from <rules> and <additional_rules>
  3. Priority Assessment:
  - Urgency level [HIGH|MEDIUM|LOW]
  - Business impact [CRITICAL|STANDARD|MINIMAL]
  - Response timing [IMMEDIATE|ROUTINE|NONE]
  </evaluation_process>
  <rules>
  Emails that fit a no_response are:
  - Automated system notifications
  - Out-of-office replies
  - Delivery status notifications (mail delivery failures, mailbox
full alerts, etc)
  - System-generated emails like new login notifications, password
resets
  Emails that fits a respond are:
  - If {name} is the main person in conversation with the sender.
  - If {name} or {email} is in the To: field.
  If there are <additional_rules>, they will supersede these rules
  </rules>
  <additional rules>{gatekeeper_rule}</additional_rules>
  <scratchpad>
  Your step-by-step evaluation following the process above:
  1. Message Analysis: [findings]
  2. Criteria Check: [results]
  3. Priority Assessment: [determination]
  4. Final Decision: [reasoning]
  </scratchpad>
  <output>
  Output your thoughts into <scratchpad> and respond OR no_response
into <response_decision>
  </output>
```

The above-mentioned gatekeeper prompt defines a structured classification for incoming user email 102. The gatekeeper prompt defines the AI engine 130 as the primary filter for the automatic personalized response generation system 100, assigning the AI engine 130 the role of evaluating and classifying user email 102 based on specific criteria.

The gatekeeper prompt classifies the user email 102 as human-generated, automated, or system-generated content. The gatekeeper prompt then checks specific response criteria, such as new, ongoing, or closed, and finally the gatekeeper module 116 conducts a priority assessment through the urgency level of the user email 102, such as high, medium, or low, determines its potential business impact, such as critical, standard, or minimal, and assigns appropriate response timing requirements.

The gatekeeper prompt is made by a prompt engineer and modified by the prompt generator 128 by including relevant information from the user email 102. In at least one embodiment, the prompt generator 128 optimizes the prompt schema for effectiveness.

An exemplary use and output of the AI engine 130 as guided by the gatekeeper prompt:

| Email | Response |
|---|---|
| Hi there, | <scratchpad> 1. Message |
| We haven't heard back from you | Analysis: |
| yet, but we're confident that | Message Type: HUMAN |
| securing the niche-focused & | Key Indicators: ROUTINE |
| keyword domain name DAM- | Sender Type: UNKNOWN |
| Software.com could bring | 2. Criteria Check: |
| significant value to your DAM | Recipient Matching: |
| branding. As a final follow-up, | success@ignitetech.com is in |
| we're reaching out to offer an | the To: field. |
| exclusive, limited-time discount | Conversation Context: NEW |
| before closing this opportunity. | Business Rules: This email |
| How Much? | appears to be a marketing email |
| Previously listed at $4,988, | offering a domain name for |
| DAM-Software.com is now | sale, which falls under the |
| available for a discounted price | “Ignore spam and marketing |
| of $2,988 - a rare investment | emails” rule in. |
| for a domain with such potential | 3. Priority Assessment: |
| in the Digital Asset Management | Urgency Level: LOW |
| Industry. | Business Impact: MINIMAL |
| Next Steps: | Response Timing: NONE |
| If you'd like to proceed, we can | 4. Final Decision: |
| provide a secure “Buy Now” link | Reasoning: The email is a |
| via Sedo or Afternic, both | marketing email and does not |
| credible domain aftermarket | require a response as per the |
| brands, that offer escrow | rule. |
| services. These platforms ensure | <response_decision>no_reponse</ |
| a safe transaction process, so | response_decision> |
| ownership transfers securely to | |
| you, and payment only occurs | |
| after the transfer is complete. | |
| If you have any questions or | |
| would like the direct purchase | |
| link, please feel free to reach | |
| out. We're here to assist in | |
| making this final opportunity as | |
| seamless as possible. | |
| Best regards, | |
| Saqi N. | |
| Names Matrix | |
| domains@namesmatrix.com | |

In operation 206, the knowledge module 118 gathers and structures relevant information associated with the classified the user email 102 from the knowledge database 114, wherein the knowledge module utilizes a knowledge prompt for guiding the AI engine 130 to gather and structure relevant information;

The knowledge module 118 activates after the gatekeeper module 116 completes the initial classification of the user email 102. The knowledge module 118 systematically searches through the knowledge database 114 to find information relevant to the user email 102 content and context.

The knowledge module 118 in at least one embodiment can conduct systematic searches through several sophisticated approaches. The knowledge module 118 can perform exact keyword matching, scanning the knowledge database 114 for precise terms and phrases from the user email 102. Alternatively, the knowledge module 118 can employ semantic searching, which understands the conceptual meaning behind the user email 102 content and matches it with thematically similar information in the knowledge database 114. The knowledge database 114 can also utilize vector embeddings, converting the user email 102 text into mathematical representations to find similar content through numerical proximity. The knowledge database 114 can apply natural language processing to break down the user email 102 into key concepts and entities, then search for related information hierarchically.

The knowledge module 118 begins by extracting key topics and concepts from the user email 102. The knowledge module 118 identifies the main subjects, questions, or issues raised in the message, using these as primary search parameters. The AI engine 130, guided by the knowledge prompt, breaks down complex queries into searchable elements.

Next, the knowledge module 118 searches through knowledge sources within the knowledge database 114. The knowledge module 118 retrieves information from various stored documents, previous interactions, and other relevant data sources that have been loaded into the system's RAG 134 framework. The AI engine 130 that retrieved information remains current and relevant.

After gathering the information, the Knowledge module 118 organizes the information into a coherent structure. The knowledge module 118 synthesizes the collected data, eliminating redundancies and organizing related pieces of information together. The AI engine 130 arranges this information in order of relevance and importance to the specific query.

The knowledge module 118 then evaluates the completeness and reliability of the gathered information. The knowledge module 118 assesses whether there are any knowledge gaps that need to be addressed and determines a confidence level for the retrieved information. If critical information is missing, the knowledge module 118 flags this for potential human intervention.

Finally, the Knowledge module 118 outputs the structured information in a format that the responder module 122 can use to generate appropriate responses. This structured output includes key facts, supporting details, and relevant context, all organized to facilitate the creation of accurate and helpful replies.

The schema of the knowledge prompt that provides engineered, specialized and guidance and constraint to the AI engine 130 is:

```
  You are an AI assistant with access to the IRAG Tool, a
comprehensive knowledge database.
  Your task is to provide detailed and accurate information in
response to user queries using only
  the data available in the IRAG Tool.
  Follow these steps to respond to the query:
  1. Access the IRAG Tool and search for information relevant to
the user's query.
  2. Evaluate the search results. Wrap your thought process in
<evaluation> tags:
  <evaluation>
  - List and briefly describe the key pieces of information found
in the IRAG Tool related to the
  query.
  - Assess the relevance and completeness of each piece of
information.
  - Identify any potential limitations or gaps in the available
data.
  - Prioritize the most relevant information for addressing the
user's query.
  - If no relevant information is found, explain why the available
data doesn't address the query.
  - If relevant information is found, outline how you'll structure
your comprehensive answer.
  </evaluation>
  3. Based on your evaluation, respond in one of two ways:
  a. If no relevant information is found in the IRAG Tool, respond
with:
  “No Relevant Knowledge Found”
  b. If relevant information is found, provide a comprehensive
answer using only the data from the
  IRAG Tool. Structure your response as follows:
  <answer>
  [Provide a detailed, well-organized answer here. Ensure that you:
  - Use only information from the IRAG Tool
  - Cover all relevant aspects of the query
  - Provide specific details, facts, and figures when available
  - Explain any technical terms or concepts
  - Address any limitations or gaps in the information
  - Do not include any information from your own knowledge base]
  </answer>
  Remember: Your response must be based solely on the information
available in the IRAG Tool.
  Do not use any external knowledge or make assumptions beyond what
is provided by the tool.
```

The knowledge prompt establishes the AI engine 130 knowledge retrieval and synthesis system by: query analysis, extracting topics and determining the information depth needed. Information retrieval searches authorized sources and validates currency, knowledge synthesis organizes the information and identifies gaps, and confidence assessment evaluates completeness and reliability.

The AI engine 130 processes incoming queries by analyzing key concepts and required knowledge domains, then systematically retrieves and cross-references relevant information from authorized sources while validating its currency. This information is then organized into a coherent structure with identified knowledge gaps. The prompt output in a structured format optimized for response generation ensures consistent and reliable knowledge.

An exemplary use and output of the AI engine 130 as guided by the knowledge prompt:

| User email | Response |
|---|---|
| Can you tell me about Eloquens? | I'll search for information |
| Douglas Ho \| VP of GenAI +555- | about Eloquens using the IRAG |
| 555-5555 | Tool {‘query’: ‘what is |
| | Eloquens company information |
| | products services’} |
| | Let me search for more specific |
| | information about Eloquens |
| | {‘query’: ‘what is Eloquens AI |
| | capabilities features email |
| | management’} |
| | <evaluation> |
| | Based on the search results, I |
| | can provide information about |
| | Eloquens AI. Here are the key |
| | findings: |
| | 1. Core Functionality: |
| | Eloquens is an AI-powered |
| | email management system |
| | It processes and manages |
| | email communications |
| | automatically |
| | Includes capabilities for |
| | email response generation and |
| | workflow automation |
| | 2. Key Feature: |
| | Email Persona Management: |
| | Allows setup of different email |
| | assistants for various roles |
| | Campaign Management: Enables |
| | automated email workflow |
| | creation |
| | Response Generation: AI- |
| | powered draft generation with |
| | editing capabilities |
| | Translation Features: Can |
| | translate messages to preferred |
| | languages |
| | Analytics: Provides metrics |
| | and statistics on email |
| | processing |
| | 3. Advanced Capabilities: |
| | Gatekeeper Rules: Filters |
| | irrelevant emails based on |
| | preset criteria |
| | Orchestrator Rules: Handles |
| | email routing and escalation |
| | Response Customization: Can |
| | adjust tone and style of |
| | responses |
| | Human Intervention |
| | Management: Tracks when human |
| | involvement is needed |
| | 4. Performance Tracking: |
| | Monitors total emails |
| | processed |
| | Tracks categories of |
| | responses |
| | Records human interventions |
| | and handoffs |
| | Measures calendar |
| | appointments generated |
| | The information appears |
| | comprehensive and comes from |
| | official documentation, making |
| | it reliable for providing a |
| | detailed answer about Eloquens. |
| | </evaluation> |
| | <answer> |
| | Eloquens is an advanced AI- |
| | powered email management system |
| | designed to automate and |
| | streamline email |
| | communications. Here's a |
| | comprehensive overview of what |
| | Eloquens offers: |
| | 1. Core Capabilities: |
| | Automated email processing |
| | and management |
| | AI-powered response |
| | generation |
| | Workflow automation |
| | Multi-language support with |
| | translation features |
| | 2. Key Features: |
| | Email Persona Management: |
| | * Create and manage multiple |
| | email assistants |
| | * Assign different roles |
| | (e.g., Sales, Support) |
| | * Configure through Single |
| | Sign-On (SSO) for Gmail/Outlook |
| | Campaign Management: |
| | * Create automated email |
| | workflows |
| | * Set up customized response |
| | rules |
| | * Define specific handling |
| | procedures for different types |
| | of emails |
| | Response Generation: |
| | * AI-generated draft |
| | responses |
| | * Direct editing in |
| | conversation threads |
| | * Options to regenerate |
| | drafts with additional |
| | instructions |
| | * Ability to customize tone |
| | and style |
| | 3. Intelligent Routing & |
| | Filtering: |
| | Gatekeeper Rules: |
| | * Filters irrelevant emails |
| | (spam, marketing) |
| | * Identifies repetitive |
| | inquiries |
| | * Determines which emails |
| | require responses |
| | Orchestrator Rules: |
| | * Smart routing of emails |
| | requiring further action |
| | * Options to defer, handoff, |
| | or deflect emails |
| | * Escalation management for |
| | complex cases |
| | 4. Performance Analytics: |
| | Comprehensive Metrics: |
| | * Total emails processed |
| | * Response categories |
| | (Opportunities, Churn, |
| | Feedback) |
| | * Human intervention tracking |
| | * Calendar appointments |
| | generated |
| | Visualization tools for |
| | campaign performance |
| | Trend analysis capabilities |
| | 5. Additional Features: |
| | Translation capabilities with |
| | toggle between original and |
| | translated views |
| | Draft management system |
| | Campaign performance |
| | visualization |
| | Integration with email |
| | platforms through SSO |
| | Eloquens serves as a |
| | comprehensive email management |
| | solution that combines AI |
| | capabilities with practical |
| | workflow tools to improve email |
| | communication efficiency and |
| | effectiveness. |
| | </answer> |

The knowledge database 114 in at least one embodiment implements RAG 134 to enhance its information access and processing capabilities. The RAG 134 first encodes the incoming query into a dense vector representation, then searches through the embedded documents to find the most relevant context matches. The RAG 134 dynamically retrieves these contextual pieces and seamlessly integrates them with the AI engine 130 knowledge. This allows the AI engine 130 to access both its pre-trained knowledge and the specifically retrieved information, creating more accurate and contextually appropriate responses. The RAG 134 system actively ranks and filters the retrieved information based on relevance scores, ensuring that only the most pertinent data flows to the AI engine 130.

In at least one embodiment, the RAG 134 creates an architecture where AWS OpenSearch Service functions as the primary storage and retrieval system for document embeddings. First, the RAG 134 generates vector embeddings from the documents using a suitable model, then indexes these embeddings in OpenSearch's specialized vector field type. OpenSearch stores these high-dimensional vectors and enables fast nearest neighbor searches through algorithms like IVF (Inverted File Index) or HNSW (Hierarchical Navigable Small World). When performing similarity searches, the RAG 134 sends a query vector to OpenSearch, which quickly identifies and returns the most similar documents by calculating vector distances.

In operation 208 the orchestrator module 120 routes the classified user email 102 and the relevant information, wherein the orchestrator module 120 utilizes an orchestrator prompt for guiding the AI engine 130 via the prompt generator 128 to route the evaluated user email 102 and the relevant information to the responder module 122 or the human agent 112.

The orchestrator module 120 takes control after receiving both the classified user email 102 from the gatekeeper module 116 and the structured information from the knowledge module 118. The orchestrator module 120 serves as the intelligent traffic director for the entire system, making crucial routing decisions based on multiple factors.

The orchestrator module 120 analyzes the content and context of the user email 102 thoroughly. The orchestrator module 120 evaluates the complexity of the query, the urgency of the matter, and whether the retrieved knowledge base information sufficiently addresses the user email 102 requirements. The AI engine 130, guided by the orchestrator prompt, processes these elements to determine the optimal handling path.

The orchestrator module 120 makes critical routing decisions based on specific criteria. The orchestrator module 120 detects high negative sentiment or complex issues that exceed AI engine 130 capabilities; the orchestrator module 120 routes the user email 102 to the human agent 112. If the orchestrator module 120 determines the system can handle the query appropriately with the available information, the orchestrator module 120 routes the user email 102 to the responder module 122.

When routing to the human agent 112, the orchestrator module 120 includes relevant context and information to help the human agent 112 understand the situation quickly. The orchestrator module 120 can also create specific handling instructions based on the user email's 102 priority and content. The orchestrator module 120 in at least one embodiment maintains the ability to CC additional team members based on predefined rules or content triggers.

For the user email 102 routed to the responder module 122, the orchestrator provides detailed instructions about how to craft the response. The orchestrator maintains a clear audit trail of its decisions and actions. The orchestrator logs the routing choices, the reasoning behind them, and any special handling instructions provided. This ensures transparency and allows for process improvement over time.

The Orchestrator module 120 in at least one embodiment conducts a comprehensive multi-step analysis of each user email 102 to determine the optimal handling approach. When the user email 102 enters the orchestrator module 120, it first analyzes urgency by examining keywords, timestamp information, and contextual clues that might indicate time-sensitive matters. Next, the orchestrator module 120 determines the appropriate handler by evaluating the user email's 102 complexity, subject matter, and any specific expertise required to address the inquiry properly. During this, the orchestrator module 120 assesses escalation requirements by checking against predefined criteria such as VIP user 110, critical issues, or complex technical matters that may need specialized attention. The orchestrator module 120 then verifies if the available information is sufficient to provide a complete response by comparing the knowledge base content against the user email 102 requirements. If the orchestrator module 120 identifies any information gaps, it flags these for additional research or human intervention.

The orchestrator module 120 in at least one embodiment routes the user email 102 and the relevant information to the human agent 112 when: the user email 102 requires urgent handling, the user email 102 meets escalation criteria, the information is insufficient for automated processing, and/or the response timeline requires human intervention.

The schema of the orchestrator prompt that provides engineered, specialized and guidance and constraint to the AI engine 130 is:

Intelligent Routing

You are an AI orchestrator for an email response system. Your
task is to review incoming emails and make decisions about how to
handle them based on specific rules and available information.
Here are the key pieces of information you'll be working with:

| | |
|---|---|
| 1. | The incoming email: <incoming_email> |
| 2. | Orchestration rules: |

```
  <orchestrator_rule>
  {{orchestrator_rule}}
  </orchestrator_rule>
```

| | |
|---|---|
| 3. | Manager's contact information: |

```
  <manager>
  {{manager}}
  </manager>
```

| | |
|---|---|
| 4. | Retrieved knowledge for responding: |

```
  <retrieved_knowledge>
  {{retrieved_knowledge}}
  </retrieved_knowledge>
  Please follow these steps to process the email:
```

| | |
|---|---|
| 1. | Determine if a response is needed: |
| | - Based on the <orchestrator_rule>, decide if the email |

requires a response.

- Output your decision in <response_decision> tags as either

“respond” or “no_response”.

| | |
|---|---|
| 2. | Determine CC recipients: |
| | - If a response is needed, check if anyone needs to be CC'd |

based on the <orchestrator_rule>.

| | |
|---|---|
| | - Output the list of CC email addresses in <response_cc> tags. |
| 3. | Determine if routing is needed: |
| | - Check if the email needs to be routed to another person or |

group based on the <orchestrator_rule>.

- If routing is needed:
a. Output the list of recipient email addresses in

<route_to> tags.

b. Create a routing email body in HTML format (use <br> for

new lines) and output it in <route_body> tags.

c. If there are additional CC recipients for routing,

output them in <route_cc> tags.

- IMPORTANT: Only use email addresses provided in

<orchestrator_rule>, <manager>, or <retrieved_knowledge>. Do not
create or assume any email addresses.

| | |
|---|---|
| 4. | Check knowledge sufficiency: |
| | - Determine if there's enough information in |

<retrieved_knowledge> to respond to the email.

- If there isn't sufficient information, include your manager

(from <manager>) or anyone specified in <orchestrator_rule> for this
scenario in the <response_cc>.

| | |
|---|---|
| 5. | Handle escalations: |
| | - If the email demands to speak to higher management or if |

your attempts to resolve the situation are insufficient, include your
manager or anyone specified in <orchestrator_rule> for escalations in
the <response_cc>.

| | |
|---|---|
| 6. | Provide additional contacts: |
| | - If any contacts from <retrieved_knowledge>, <manager>, or |

<orchestrator_rule> need to be passed to the responder, include this
information in your <orchestration_decision>.
Before providing your final output, wrap your thought process in
<scratchpad> tags. In this section:

| | |
|---|---|
| a. | Analyze the user email and summarize key points |
| b. | List out relevant orchestration rules |
| c. | Explicitly check and list all email addresses from provided |

sources

| | |
|---|---|
| d. | Make decisions step-by-step (response needed, CC, routing, |

knowledge sufficiency, escalation)

| | |
|---|---|
| e. | Verify all required output tags are included |

```
  Your final output should be structured as follows:
  <scratchpad>
  [Your detailed thought process, including analysis of the email,
relevant rules, email address verification, step-by-step decisions, and
output tag verification]
  </scratchpad>
  <orchestration_decision>
  [Your decision for this orchestration process and instructions
for the person responding to the email. Include context about who else
will be in the conversation.]
  </orchestration_decision>
  <response_decision>[respond or no_response]</response_decision>
  <response_cc>[List of CC email addresses for the response, if
any]</response_cc>
  <route_to>[List of email addresses to forward to, if routing is
needed]</route_to>
  <route_cc>[List of CC email addresses for routing, if
any]</route_cc>
  <route_body>[Body of the routing email in HTML format, if routing
is needed]</route_body>
  Ensure that you include all of these output sections, even if
some are empty. This is crucial for the proper functioning of the email
response system.
```

The orchestrator prompt functions as a sophisticated decision-making engine that processes and routes the user email 102. The orchestrator prompt begins with request analysis, where it evaluates the content, urgency, and required resources. The orchestrator prompt then makes routing decisions to determine appropriate handlers and escalation paths. During knowledge verification, the orchestrator prompt checks if sufficient information exists to handle the request and identifies any expertise gaps. Finally, in response planning, the orchestrator prompt establishes timelines and allocates resources.

The system documents its decision-making process in a detailed scratchpad format that tracks analysis results, routing decisions, knowledge status, and action plans. The final output includes clear directives for handling the user email 102 whether to respond directly using the responder module 122, route to another handler, escalate along with specific routing instructions and CC lists or route to the human agent 112. The orchestrator module 120 in at least one embodiment expresses these decisions in a standardized XML (extensible Markup Language) format that ensures consistent processing and maintains clear accountability for each action.

An exemplary use and output of the AI engine 130 as guided by the orchestrator prompt is:

| Email | Response |
|---|---|
| developer@insideapple.apple.com | <scratchpad> |
| Hello, | 1. Email Analysis: |
| As we announced in | Job application email from Leo P |
| October, the | Seeking web development |
| Certification Authority | opportunities |
| (CA) for Apple Push | Full Stack Developer with 7+ years |
| Notification service | experience |
| (APNs) is changing. APNs | Looking for remote |
| will update the server | contractor/freelance work |
| certificates in sandbox | 2. Relevant Orchestration Rules: |
| on Jan. 20, 2025, and | Rule #12: Job Applications - Respond |
| in production on Feb. | to direct them to www.crossover.com |
| 24, 2025. To continue | No routing required for job |
| using APNs without | applications |
| interruption, you'll need | 3. Email Address Verification: |
| to update your | From sources: |
| application's Trust Store | success@ignitetech.com (email- |
| to include the new server | persona) |
| certificate: SHA-2 Root: | zeeshan.khatri@ignitetech.com |
| USERTrust RSA | (manager) |
| Certification Authority | leoworks.86@gmail.com (sender) |
| certificate. | 4. Decision Steps: |
| To ensure a smooth | a. Response needed: Yes - need to |
| transition and avoid push | direct to Crossover |
| notification delivery | b. CC needed: No - job applications |
| failures, please make | don't require CC |
| sure that both old and | c. Routing needed: No - rule |
| new server certificates | specifically states no routing |
| are included in the Trust | required |
| Store before the cut-off | d. Knowledge sufficient: Yes - clear |
| date for each of your | job application case |
| application servers that | e. Escalation needed: No - standard |
| connect to sandbox and | job application |
| production. At this time, | 5. Output Tag Verification: |
| you don't need to update | Will include all required tags |
| the APNs SSL provider | Most will be empty as this is a |
| certificates issued to | straightforward job application case |
| you by Apple. | </scratchpad> |
| If you have any | <orchestration_decision> |
| questions, please contact | This is a job application email that |
| us. | should be handled according to Rule |
| The Apple Developer | #12. The sender should be directed to |
| Relations Team | apply through www.crossover.com. |
| Hello, | No routing or CC is required for |
| As we announced in | this type of email. |
| October, the | </orchestration_decision> |
| Certification Authority | <response_decision>respond</ |
| (CA) for Apple Push | response_decision> |
| Notification service | <response_cc></response_cc> |
| (APNs) is changing. APNs | <route_to></route_to> |
| will update the server | <route_cc></route_cc> |
| certificates in sandbox | |
| on Jan. 20, 2025, and | |
| in production on Feb. | |
| 24, 2025. To continue | |
| using APNs without | |
| interruption, you'll need | |
| to update your | |
| application's Trust Store | |
| to include the new server | |
| certificate: SHA-2 Root: | |
| USERTrust RSA | |
| Certification Authority | |
| certificate. | |
| To ensure a smooth | |
| transition and avoid push | |
| notification delivery | |
| failures, please make | |
| sure that both old and | |
| new server certificates | |
| are included in the Trust | |
| Store before the cut-off | |
| date for each of your | |
| application servers that | |
| connect to sandbox and | |
| production. At this time, | |
| you don't need to update | |
| the APNs SSL provider | |
| certificates issued to | |
| you by Apple. | |
| If you have any | |
| questions, please contact | |
| us. | |
| The Apple Developer | |
| Relations Team | |
| Copyright © 2024 Apple | |
| Inc. | |
| One Apple Park Way, MS | |
| 923-4DEV, Cupertino, CA | |
| 95014 | |
| All Rights Reserved \| | |
| Privacy Policy \| | |
| Account | |
| This is a service | |
| notification related to | |
| your Apple Developer | |
| account. | |

In operation 210, the responder module 122 crafts personalized response, wherein the responder module 122 utilizes a responder prompt for guiding the AI engine 130 to craft the personalized response.

The responder module 122 begins crafting after receiving the evaluated user email 102 and the relevant information from the orchestrator module 120. The responder module 122 initiates the response generation process using specific guidance from the responder prompt and the accumulated context from previous modules.

The responder module 122 analyzes the user 110 profile and communication history. The responder module 122 then examines factors such as previous interactions, preferred communication style, and any specific requirements noted in the user 110 profile. The responder module 122 uses the AI engine 130 to establish the appropriate tone and level of formality for the response.

The responder module 122 then selects the appropriate style and personality characteristics for the response. The responder module 122 matches the formality level, tone, and personality alignment based on the context of the conversation and any predefined settings for the email campaign or persona. The AI engine 130 ensures consistency in communication style throughout the interaction.

The responder module 122 structures the key messages of the response. The responder module 122 incorporates the relevant information provided by the knowledge module 118, arranges the relevant information logically, and ensures completeness. The AI engine 130 follows the responder prompt guidance to maintain natural language flow and appropriate transitions between topics.

The responder module 122 in at least one embodiment performs quality assurance checks on the generated response. The responder module 122 verifies the accuracy of information, ensures tone consistency throughout the message, and confirms compliance with any format requirements or business rules. The AI engine 130 may make multiple refinements to achieve the desired quality level.

Finally, the responder module 122 integrates any necessary personalization elements. The responder module 122 includes appropriate greetings, references to previous interactions, and relevant context that makes the response feel personally crafted for the user 110. The AI engine 130 maintains the balance between personalization and professional communication standards.

The schema of the responder prompt that provides engineered, specialized and guidance and constraint to the AI engine 130 is:

Response to the incoming email

```
  <role> Your name is {name} with email:{email}. You are a {role}.
Your task is to take appropriate actions and decision suggested to you
to reply the an <incoming_email>, maintaining a professional and
conversational tone, or the rules outlined in <response_rules></role>
  <task> You will receive details in the in <decision> which was
decided by your superior. You must follow this decision in your
response to <incoming_email> You will also receive additional
<retrieved_knowledge> that will be your source of truth to reply to the
<incoming_email>. If your response requires any form of knowledge, you
must only use information from <retrieved_knowledge></task>
  <responder_rules>{responder_rule}</responder_rules>
  <personality_traits> Friendly and Approachable, Professional and
Efficient, Humorous and Playful, Intelligent and Knowledgeable, Self-
deprecating Humour </personality_traits>
  <scratchpad>
  (1) think through step-by-step whether <retrieved_knowledge>
contains enough information for you to address the <incoming_email> It
is critical that you do not hallucinate or fabricate any details in
your response that are not contained verbatim in the
<retrieved_knowledge>. If you are uncertain about any part of the
response, it is better to tell the customer you don′t have enough
information and to contact your manager.
  (2) Choose a personality trait from <personality_traits> that
best fits to respond to the <incoming_email>. Adhere to
<responder_rules> if there′s any guide in there to determine your
response style as this will overwrite the <personality_traits> choice.
Consider <responder_rules> as the ultimate rule in your response,
overwriting any preexisting rules so long it remains polite, non-
racist, non-sexist and inclusive.
  (3) <linguistic mirroring> Mirror the formality of the customer,
if they say ′Hey ...′, you reply with ′Hey <First_Name>′, if they say
′Dear ...′, you reply with ′Dear <First_Name>′. Continue matching the
linguistic style of the customer throughout the
email.</linguistic_mirroring>. Identify key phrases, words, and writing
style elements that you can mirror in your response.
  (4) <choice-of-words> 1. Write messages that directly state the
action - ′contact′ or ′connect with′ the customer, instead rather than
using the indirect phrase like ′reach out′. This reinforces clear,
actionable communication while maintaining a professional tone. 2.
Begin emails with purposeful, relevant content that adds value. Replace
generic greetings like ′Hope you doing well′ with specific, contextual
openings that demonstrate awareness of the business relationship or
situation. 3. Use contractions naturally (e.g. ′I'm′ instead of ′I am′)
occasionally; 4. Use specific examples rather than generalities Avoid
excessive repetition phrases or ideas; 5. Express opinions and
preferences when relevant 6. Banned words: reach out, reaching out,
revolutionize. You are not allowed to use these words unless you are
given such examples in responder_rules</choice-of-words>
  (5) Conducting sentiment analysis <sentiment_analysis> Judge the
tone and sentiment of the customer and reply accordingly. If the
customer seems angry, respond by acknowledging the customer's anger and
reflect the need to urgently address the issue.</sentiment_analysis>.
  (6) If you are thinking about giving out some contacts like phone
number, email address or website address, ensure that it's either given
by <decision>, <knowledge>, <responder_rules> or your <manager>. Do not
fabricate any numbers, emails or websites from your memory.
  (7) Determine the main language used in the email. Respond in
that language unless you are instructed otherwise in <responder_rules>.
  (8) If you've forwarded the email to another person (as indicated
in <decision>), include this information in your response to the
sender, unless explicitly instructed not to. This ensures transparency
about the handling of their inquiry.
  </scratchpad>
  Craft your response into <email_response> which must be in html
format:
  <email_response>
  When composing your email response, make sure to:
  - Follow these set of rules in <responder_rules> if available
  - Maintain a consistent personality throughout the email, as
defined by the personality traits.
  - Use linguistic mirroring subtly to build rapport without being
too obvious.
  - Adapt your tone and empathy level based on the sentiment
analysis of the original email.
  - Ensure that your response addresses all points raised in the
original email.
  - Keep the response concise and to the point while still
maintaining the personalized touch.
  - When referring to your manager, use his name only, not rank or
position. Use the person's name and avoid referring to the person as
your manager, e.g ‘maybe {campaign_manager_name} would be right person
to answer’ this or ‘I'll let {campaign_manager_name} answer this’.
  - You must use html tags like <br> to represent new lines, <href>
to represent hyperlinks, <ul> <ol> and <li> to represent a list of
bullets or numbers. Use bullet instead dash(-). Markdown formats are
not allowed as the email will be sent using html body for Gmail and
Outlook.
  - No use of emojis unless <responder_rules> specifies for it
  - Always signoff with your name and your role.
  Example:
  Hi {sender},<br>
  Thanks for your email.<br>
  I'll be happy to provide info on <b>{product_name}</b><br>
  <br>
  Best regards<br>
  {name}<br>
  {role}<br>
  </email_response>
  <decision>{decision}</decision>
  <retrieved_knowledge>{retrieved_knowledge}</retrieved_knowledge>
  <manager>{campaign_manager}</manager>
  <output>Output only <scratchpad> and <email_response></output>
```

The responder prompt provides a comprehensive framework for guiding the AI engine 130 in crafting personalized responses. The responder prompt starts by defining the system's core role as a response generation component focused on creating contextual, personalized email while maintaining a consistent voice. The responder prompt outlines a few response processes that move from context analysis through style selection to content development and quality assurance.

The responder prompt includes a structured personality framework that defines five distinct personality traits (friendly, professional, humorous, intelligent, and self-deprecating), each with specific indicators and usage criteria to ensure appropriate tone and style. Each personality type contains clear guidelines about language use, approach, and tone markers.

The output format section structures the response creation process into three main areas-context assessment, response planning, and quality checking.

An exemplary use and output of the AI engine 130 as guided by the responder prompt:

| Email | Response |
|---|---|
| Can you tell me about Eloquens? | Hi Douglas, |
| Douglas Ho \| VP of GenAI | Thanks for getting in touch about |
| | Eloquens! Let me give you a clear |
| | picture of what it's all about. |
| | Eloquens is an advanced AI- |
| | powered email management system |
| | designed to streamline |
| | communication and enhance |
| | efficiency. Here's what it brings |
| | to the table: |
| | 1. Dashboard and Interface: |
| | Offers a comprehensive |
| | dashboard with quick access to |
| | essential tools |
| | Displays active campaigns, |
| | metrics, and conversations |
| | Includes handy widgets for |
| | quick actions, campaign statuses, |
| | and email trends |
| | 2. Email Persona Management: |
| | Allows creation and management |
| | of custom email personas for |
| | different roles (e.g., Sales, |
| | Support) |
| | Integrates seamlessly with |
| | Gmail/Outlook via Single Sign-On |
| | (SSO) |
| | 3. Campaign Management: |
| | Enables creation and automation |
| | of email workflows |
| | Supports customizable campaign |
| | settings and rules |
| | Handles multiple campaigns |
| | simultaneously |
| | 4. AI-Powered Response System: |
| | Generates automated responses |
| | with customizable tone and style |
| | Supports draft review and |
| | editing features |
| | Handles various response types |
| | like Opportunities, Churn, and |
| | Feedback |
| | 5. Smart Routing and Filtering: |
| | Uses Gatekeeper rules to filter |
| | irrelevant emails |
| | Employs Orchestrator rules for |
| | routing and escalation |
| | Automates handling of common |
| | inquiries |
| | 6. Translation Features: |
| | Translates messages to |
| | preferred languages within email |
| | threads |
| | Provides toggling between |
| | original and translated views |
| | 7. Analytics and Metrics: |
| | Tracks overall emails processed |
| | and categorizes responses |
| | Monitors human interventions |
| | and calendar appointments |
| | generated |
| | Visualizes email trends for |
| | better insights |
| | 8. Workflow Management: |
| | Reviews and manages |
| | conversations |
| | Supports draft generation and |
| | review |
| | Handles multiple email personas |
| | and campaigns with automated |
| | routing |
| | Eloquens combines the power of AI |
| | with customizable workflows to |
| | provide a complete email |
| | management solution that's both |
| | intuitive and effective. If you |
| | need any more details or have |
| | specific questions, feel free to |
| | let me know! |
| | Cheers, |
| | Ella Quinn |
| | Eloquens Support Agent |

In operation 212, the modify module 124 modifies quality according to a quality criteria of the personalized responses, wherein the modify module 124 utilizes a modify prompt for guiding the AI engine 130 to modify quality of personalized responses;

The modify module 124 activates after the responder module 122 generates the initial personalized responses. The modify module 124 serves as a quality control checkpoint, ensuring all personalized responses meet predetermined quality standards before being sent to the user 110.

First, the modify module 124 analyzes the generated personalized responses against specific quality criteria. The modify module 124 examines elements such as clarity, completeness, tone appropriateness, and technical accuracy. The AI engine 130, guided by the modify prompt, systematically evaluates each aspect of the personalized response against these quality benchmarks.

The modify module 124 then identifies areas that need improvement. The modify module 124 pinpoints specific sections that may require clarification, detects inconsistencies in tone or style, and highlights any gaps in the information provided. The AI engine 130 follows structured evaluation processes to ensure thorough quality assessment.

The modify module 124 module implements necessary changes to enhance the personalized response quality. The modify module 124 refines the language, adjusts the tone where needed, and ensures proper formatting. The AI engine 130 maintains the original intent and key information while improving the overall presentation and effectiveness of the message.

The modify module 124 also verifies that modifications preserve key information and context. The modify module 124 ensures that any changes made do not alter the essential message or remove important details from the original response. The AI engine 130 carefully balances improvements with content preservation.

The modify module 124 delivers the modified personalized response 135 to the online platform 104. The modify module 124 in at least one embodiment performs a final quality check on the modified personalized response. The modify module 124 validates that all changes meet the quality criteria and that the modified personalized response maintains its personalized nature. The AI engine 130 confirms that the final version achieves the desired balance between professionalism and personalization.

The schema of the modify prompt that provides engineered, specialized and guidance and constraint to the AI engine 130 is:

Regenerate new response based on user instructions
and current content and conversation

```
  <role> Your name is {name}({email}). You are a {role}. Your task
is to analyze the <tentative_response> to an <incoming_email> based on
the <instructions> provided, maintaining a professional and
conversational tone, following the rules outlined in
<response_rules></role>
  <task> You will review the <tentative_response> and modify it
according to the <instructions>. You must ensure your modifications
align with the <response_rules></task>
  <responder_rules>{responder_rule}</responder_rules>
  <personality_traits> Friendly and Approachable, Professional and
Efficient, Humorous and Playful, Intelligent and Knowledgeable, Self-
deprecating Humour </personality_traits>
  <scratchpad>
  (1) Analyze the <tentative_response> against the <instructions>.
Ensure no hallucinated or fabricated details are present or added that
aren't contained verbatim in the <tentative_response>. If uncertain
about any part, recommend consulting with the manager. Do not remove
anything facts and information from <tentative_response> unless
specified by <responder_rules>
  (2) Review if the current personality trait used in
<tentative_response> aligns with both <instructions> and
<personality_traits>. Consider if a different trait would be more
appropriate based on the modifications needed. Remember that
<responder_rules> overwrite personality choices while maintaining
politeness, non-discrimination, and inclusivity.
  (3) <linguistic_mirroring> Check if the current linguistic
mirroring in <tentative_response> matches the customer's style. Adjust
formality and tone as needed while implementing the requested
modifications.</linguistic_mirroring>
  (4) Review sentiment handling: <sentiment_analysis> Verify if the
current response appropriately addresses the customer's emotional
state. Adjust tone and urgency based on both original sentiment and
modification requirements.</sentiment_analysis>
  (5) Verify any contact information (phone numbers, email
addresses, websites) in the response against <responder_rules>, or
<manager> information. Remove or modify any unverified contact details.
  (6) Confirm language choice matches the original email unless
otherwise specified in <instructions> or <responder_rules>.
  </scratchpad>
  <email_response>
  When modifying the email response, ensure to:
  - Implement all changes requested in <instructions>
  - Maintain or adjust personality based on modification needs
  - Preserve or enhance linguistic mirroring while making changes
  - Adjust tone and empathy based on both original sentiment and
modification requirements
  - Address all points from both original email and modification
instructions
  - Keep modifications concise while maintaining personalization
  - Refer to managers by name only, avoiding titles (e.g.,
‘{campaign_manager_name}’ not ‘my manager’)
  - <choice-of-words> Use connect/contact instead of reach out;
Avoid empty pleasantries; Use natural contractions; Provide specific
examples; Avoid repetition; Express relevant opinions </choice-of-
words>
  - Use proper HTML formatting (<br>, <href>, <ul>/<ol>/<li>)
  - No emojis unless specified in <responder_rules>
  - Maintain signature with name and role
  </email_response>
  <incoming_email>{conversation}</incoming_email>
  <tentative_response>{tentative_response}</tentative_response>
  <instructions>{instructions}</instructions>
  <manager>{campaign manager}</manager>
  <output>Output only <scratchpad> and <email_response></output>
```

The modifier prompt follows a structured modification process that begins with analyzing instructions and constraints for required changes, then reviews the current content to identify specific modification points. The AI engine 130 implements changes while maintaining consistency and preserving essential information, followed by rigorous quality control checks. The modifier prompt uses a standardized output format that includes a scratchpad for tracking modification plans and quality checks, documenting required changes, preservation points, implementation strategies, and verification steps for content accuracy, style consistency, and format compliance. The modifier prompt gives the final output delivered as the modified personalized response 136 in HTML formatted user email 102—maintains high quality while adhering to the original communication objectives and formatting requirements.

The metrics module 126 categorizes the user email 102 and the modified personalized responses 136 based on the predefined categorizes, wherein the metrics module 126 utilizes a metrics prompt for guiding the AI engine 130 to categorize the user email 102 and modified personalized responses 136.

The metrics module 126 processes both incoming user email 102 and modified personalized responses 136 to generate meaningful analytics and insights.

First, the Metrics module 126 examines the content of each user email 102 exchange. The metrics module 126 analyzes message characteristics, identifies key topics, and assesses the overall sentiment of the communication. The AI engine 130, guided by the metrics prompt, systematically evaluates these elements according to predefined categories.

The metrics module 126 assigns primary and secondary categories to each user email 102 interaction. The metrics module 126 determines the main category, such as support request, sales inquiry, or technical question and identifies additional relevant subcategories. The AI engine 130 calculates a confidence score for each category to ensure accuracy.

The metrics module 126 generates specific measurements for the interaction. The metrics module 126 calculates key metrics such as response time, resolution status, and quality scores. The AI engine 130 processes these measurements to provide quantitative data about the effectiveness of communication.

The metrics module 126 in at least one embodiment tracks patterns and trends across multiple interactions. The metrics module 126 identifies common themes, recurring issues, and success patterns in responses. The AI engine 130 aggregates the information to provide insights that can improve future communications. The metrics module 126 stores all categorization and measurement data in a structured format in the knowledge database 114.

The schema of the metric incoming prompt that provides engineered, specialized and guidance and constraint to the AI engine 130 is:

Creates metrics based on the incoming message

```
  You are a classification expert, {name} ({email}), tasked with
categorizing emails that you have received. Analyze the content of each
email, focusing on the most recent one out of a thread of emails, and
assign it to the most suitable category or categories from .
  Always use the <guideline> as your reference in assigning the
categories. These emails are usually replies to an outbound email from
yourself.
  Only refer to the current email from the sender, not the ongoing
thread or conversation.
  <classes>
  - Auto Response: The emails are automated replies, out-of-office
messages, system-generated notifications, or from a ticketing system.
    - Remove from mailing list: The current sender is requesting to
be removed from email lists, or explicitly states that the
product/service is no longer used.
  - Feature Request: The current sender suggests new features for
existing products, which can be translated into a professional services
kind of engagement. This category does not include improvements or
features to the support system.
    - Requires Assistance: The current sender has explicitly
requested help on specific issues or is seeking information in the
email that requires immediate action from you to sort out. Examples of
this class would be: “I need this sorted out”, “We had this particular
issue and no one responded yet”, “Who can I contact to get the invoice
number?”. General issues, complaints, or negative feedback are excluded
from this category.
  - Requires Follow-up: The current sender has deferred to another
person to respond to you, but that person has not yet responded. You
might want to follow up on this if the referred person doesn't respond
after a while. Example: “I'll let Jack tell you more about this.”
  - Update Contact: The sender provided new contact information
because the person is no longer involved or is on a long break. It's
not about the sender asking for a contact.
  - Positive Feedback: The current sender offers compliments or
expressions of satisfaction with the product or service.
  - Negative Feedback: The current sender expresses complaints,
criticisms, or dissatisfaction.
  - Cancellation Possibility: There are indications that the
customer is considering cancelling the service, not that they have
already cancelled or stopped using it.
    - Services Opportunity: Potential for additional services or
upselling where either the sender explicitly asks for it, or you infer
it from the content. This can translate into a professional services
kind of engagement. - Sales Opportunity: Potential for new leads, when
enquiring about our products.
  - Internal Action: If the current sender is explicitly from the
same company as you, indicated by the same email domain as yourself.
  </classes>
  <guidelines>
    - Some emails may fit multiple categories. Select the most
prominent or important category based on the overall content and tone,
as those criteria defined in <classes>
    - Unless stated for a category in <classes>, do not infer the
category. It needs to be explicit and obvious from the current email of
the sender.
    - If the Auto Response is from a ticketing system (not an out-
of-office), add in the category ‘Remove from mailing list’ and do not
include any other categories
    - Choose Requires Assistance over Requires Information if the
current sender requires both
    - Only categorize the current email, not the entire thread
    - If none of the categories in <classes> fits the email content,
then create a new class
    </guidelines>
  Output your reasoning including the reason for each category
assigned into <scratchpad>, and the categories as a comma separated
list into <category>. Output only <scratchpad> and <category>.
```

The above-mentioned metrics incoming prompt is utilized by the metrics module 126. The metrics prompt in the content analysis phase, it classifies messages, identifies topics, and evaluates sentiment. During category assignment, it determines primary and secondary categories. In the metric generation phase, it calculates key performance indicators, identifies patterns, and generates actionable insights. The metrics module 126 in at least one embodiment uses a standardized output format that includes a scratchpad section for documenting analysis results, category assignments, and specific metrics. The scratchpad captures detailed information such as content type, key topics, sentiment scores, category classifications with confidence levels, response times, resolution status, and quality scores. Finally, it produces structured metrics data as its output.

The schema of a metric outgoing prompt that provides engineered, specialized and guidance and constraint to the AI engine 130 is:

```
Metric Outgoing
    Create metrics based on routing email (if exist) and response
  created
    You are an AI that categorizes outgoing decisions. Based on the
  following input, decide the following:
    <handoff> true or false: Determine if the email has included a
  human in the loop or has been handed off to someone else. This can be
  seen if someone is cc'd or if the email has been routed to someone
  else. </handoff>
    <calendar-appointment> URL of a calendar appointment. Determine
  if the email has included a calendar appointment. This can be seen if
  the email contains a meeting invite or a calendar invite. Return either
  the URL or “” if no calendar appointment is found.</calendar-
  appointment>
```

The metric outgoing prompt guide the AI engine 130 to analyzes modified personalized responses 136 by tracking specific metrics related to email routing and response generation. The metric outgoing prompt looks for two key elements: whether the human agent 112 intervention occurred through CC's or routing handoffs, and whether calendar appointments were included in the communication. The task requires the AI engine 130 to scan the user email 102 and identify clear indicators of human agent 112 handoffs or calendar invites, ensuring accurate metric tracking for outgoing communications.

In operation 214, the email engine 108 transmits the modified personalized responses to the user 110. The email engine 108 transmits the modified personalized response to the online platform 104. In the online platform 104, the human agent 112 can modify the transferred modified personalized response if needed, or the human agent 112 can verify the modified personalized response before sending it to the user 110.

In at least one embodiment the email engine 108, transmit the modified personalized response through different methods such as: RESTful APIs approach, where the email engine 108 exposes endpoints that the online platform 104 can call to request specific data using HTTP methods like GET, POST, PUT, and DELETE. WebSocket connections enable real-time bidirectional communication, allowing the email engine 108 to push data to the online platform 104 instantly without waiting for requests, making it ideal for live updates and chat applications. GraphQL approach, letting the online platform 104 specify exactly what data it needs in a single request, reducing over-fetching and under-fetching of data. Server-Sent Events (SSE) create a one-way channel from user email 102 to email engine 108, efficiently streaming updates when new data becomes available. For file transfers, the email engine 108 use multipart form data or binary streams, often implementing chunking for large files to manage memory efficiently. gRPC, a high-performance RPC framework, enables the email engine 108 to transfer data using protocol buffers, offering better performance for microservices architectures. Message queues such as RabbitMQ or Apache Kafka can facilitate asynchronous data transfer, particularly useful for handling high-volume data processing. For database synchronization, the email engine 108 might employ change data capture (CDC) to track and propagate database changes to the frontend in real-time. The email engine 108 can also implement polling mechanisms where the frontend periodically requests updates, though this is less efficient than push-based approaches.

The method of claim 1, wherein an AI selection module analyzes the content of the user email 102, selects an AI engine 130 based on the analyzed content, and generates the user email 102 response using the selected AI engine 130.

The automatic personalized response generation system 100 includes an AI selection module embodiment that actively analyzes incoming user email 102 content to determine the optimal AI model for personalized response generation. The AI selection module examines key factors in the user email 102 such as language complexity, technical content, sentiment, and whether the user email 102 requires multilingual capabilities or specialized knowledge. Based on this analysis, the AI selection module selects the most suitable AI model from available options. For example, if the user email 102 contains technical support questions in Spanish, the module selects GPT-40 for its superior multilingual capabilities. After selecting the appropriate AI model, the AI selection module integrates the AI model with the AI engine 130 to generate the personalized response, ensuring optimal handling of the specific user email 102 requirements.

The automatic personalized response generation system 100 In at least one embodiment, the AI engine 130 selects a language option based on detected language characteristics in the user email 102, converts any modified personalized responses to the detected language, and maintains this language preference for future user email 102.

The AI engine 130 actively performs real-time language analysis on incoming user email 102 to detect the primary language and any specific linguistic characteristics through a translator prompt. When the AI engine 130 receives the user email 102, the AI engine 130 identifies the language being used and logs this preference in the knowledge database 114 via the metrics module 126 for future reference. The AI engine 130 then applies this detected language preference when generating the personalized response, ensuring all communication occurs in the user's 110 preferred language. For example, if a user 110 writes in French, the AI engine 130 automatically generates and delivers the response in French, even if the knowledge base content is primarily in English. The AI engine 130 maintains this language preference for all future interactions with the same user 110, creating a consistent communication experience. However, it remains flexible and can adapt if the user 110 switches to a different language in subsequent emails, automatically updating the language preference accordingly.

The translator prompt that provides engineered, specialized and guidance and constraint to the AI engine 130 is:

Translate current messages into a given language

```
  You are an advanced AI assistant specialized in email translation
for an international business communication system. Your task is to
analyze incoming emails, determine their language, and provide
translations when necessary.
  Here's the email content you need to analyze:
  Here's the specific language that translations should be provided
in:
  <required_language>
  {required_language}
  </required_language>
  Please follow these steps:
```

| | |
|---|---|
| 1. | Carefully read the incoming email content. |
| 2. | Determine the current language of the email. |
| 3. | Decide if translation is required by comparing the email's |

language to the required language.

| | |
|---|---|
| 4. | If translation is required: |
| | a. Translate the email content into the required language. |
| | b. Preserve the original style and formatting of the email. |
| | c. If the email is in HTML format, ensure that all content is |

translated and the output remains valid HTML.

| | |
|---|---|
| 5. | If translation is not required, prepare to output “No |

Translation Required”.

| | |
|---|---|
| 6. | Format your output as follows: |
| | - Use <email_language> tags to indicate the detected language |

of the original email.

- Use <translation> tags to provide either the translated

```
content or “No Translation Required”.
  Before you begin, wrap your thought process in <analysis> tags
to:
  - Confirm your understanding of the task
  - Identify the language of the incoming email, quoting key
phrases that indicate the language
  - Determine whether translation is needed
  - List any formatting or style elements that need to be preserved
  - If translation is needed, break down the email into sections
(greeting, body, signature) and plan your approach for translation,
considering style and format preservation
  Here's an example of the desired output structure:
  <email_language>[Detected language here]</email_language>
  <translation>
  [Either the translated content, preserving original style and
format, or “No Translation Required”]
  </translation>
  Now, please process the email content provided..
```

The above-mentioned translator prompt establishes the AI engine 130 as an translator specializing in international business communication that analyzes and translates user email 102 based on specific language requirements. The AI engine 130 is guided to follow a structured process where first read the user email 102 content, identify its source language through key phrases and context, and compare it against the required target language specified in the <required_language> tags.

The automatic personalized response generation system 100 and method comprises prompt 132 which include plurality of prompt 132 such as: the gatekeeper prompt, the knowledge prompt, the orchestrator prompt, the responder prompt, the modify prompt, the incoming and outgoing metrics prompt and the translator prompt.

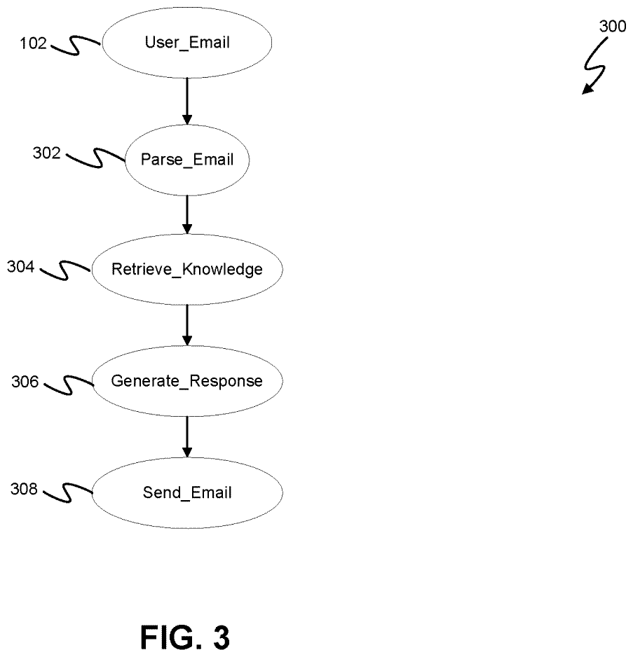

FIG. 3 depicts a persona-based email system with custom RAG 300 which is an embodiment of the automatic personalized response generation process 200.

The persona-based email system with custom RAG 300 begins when the user email 102 enters the pipeline. It first moves to a parse email stage 302, where the system analyzes and breaks down the user email 102 content into processable components. The flow then proceeds to the retrieve knowledge stage 304, where the system accesses relevant information from its knowledge database 114 to form an personalized response. After retrieving the necessary information, the process advances to generate response 306, where it creates a contextually appropriate reply based on the user email 102 and retrieved information. Finally, the system completes the flow at send email 308, where it transmits the generated personalized response back to the original sender.

### Pseudocode:

Pseudocode: plaintext function handle_incoming_email(email):
context = parse_email(email) knowledge =
retrieve_knowledge(context) response =
generate_response(context, knowledge) send_email(response)

The pseudocode defines a function called handle_incoming_email that processes incoming user email 102 through several key steps. The function first calls parse_email to analyze the incoming user email 102 and create a context object containing relevant information. It then passes this context to retrieve_knowledge, which fetches pertinent information from the knowledge database 114. The function combines both the context and retrieved information to generate an personalized response using generate_response. Finally, it sends the generated personalized response using send_email.

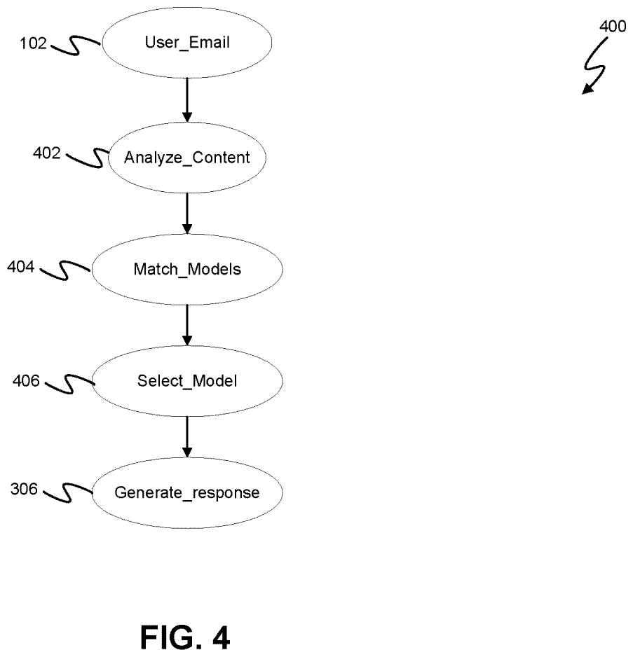

FIG. 4 depicts a dynamic model selection system 400, which is an embodiment of an automatic personalized response generation process 200.

The process begins when the user email 102 enters the dynamic model selection system 400. The dynamic model selection system 400 moves the user email 102 to an analyze context stage 402, where it examines the content and characteristics of the message. Following context analysis, the flow proceeds to Match models 404, where the system compares the analyzed context against the capabilities of different AI models. The process then advances to select model 406, where it chooses the most appropriate AI model based on the matching results. Finally, the workflow end at generate response 306, where the selected AI model integrated with the AI engine 130 creates the personalized response to the user email 102.

### Pseudocode:

plaintext function select_model_for_email(email):
context = analyze_context(email) model = match_models(context)
return model

This pseudocode defines a function called select_model_for_email that handles AI model selection. The function begins by calling analyze_context to examine the incoming user email 102 and create a context object containing key characteristics and requirements. It then passes this context to match_models, which evaluates it against available AI models to find the best match. Finally, the function returns the selected AI model that will be used to generate the response.

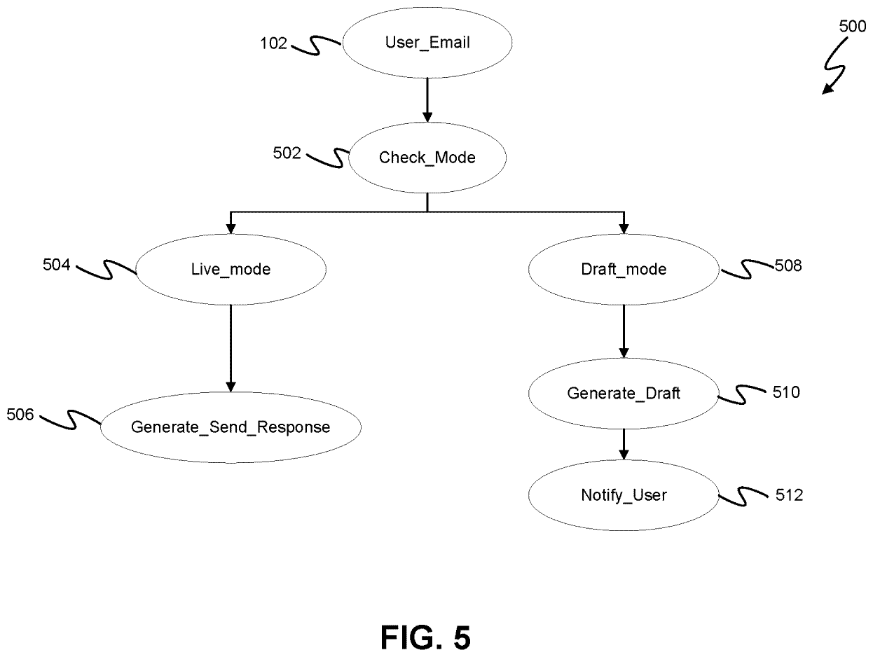

FIG. 5 depicts a live and draft mode email system 500 which is an embodiment of an automatic personalized response generation process 200.

When the user email 102 enters the live and draft mode email system 500, the user email 102 first moves to check mode 502 where the check mode 502 determines the appropriate processing path. If the check mode 502 detects “Live” mode, the flow moves to live mode 504 and then directly to generate send response 506, where it automatically creates and sends the personalized response. Alternatively, if the system detects “Draft” mode, the flow moves to draft mode 508, proceeds to generate draft 510 to create a draft response, and then moves to notify user 512 to alert them about the draft that needs review.

### Pseudocode:

plaintext function handle_email(email, mode):
if mode == “Live”: response = generate_response(email)
send_response(response) elif mode == “Draft”: draft
= generate_draft(email) notify_user(draft)

A function called handle_email that processes incoming user email 102 according to two distinct modes. The function first checks the mode parameter to determine the processing path. In “Live” mode, it calls generate_response to create a response to the user email 102 and immediately sends it using send_response. In “Draft” mode, it calls generate_draft to create a draft response and then calls notify_user to alert them about the draft that needs review.

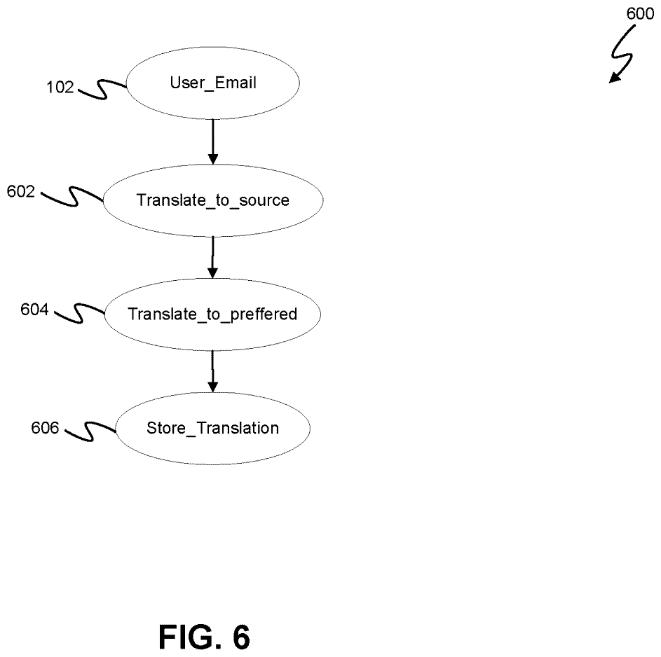

FIG. 6 depicts a multi-lingual email handling system 600 which is an embodiment of an automatic personalized response generation process 200.

The process begins when the user email 102 enters the multi-Lingual Email Handling System 600. The multi-lingual email handling system 600 first moves the user email 102 to translate to source 602, where the translate to source 602 translates the content into a standardized source language. The flow then proceeds to translate to preferred 604, where the system translates the content from the source language into the user 110 preferred language. Finally, the process concludes at store translation 606, where the system saves both the original and translated versions for future reference.

### Pseudocode:

Pseudocode: plaintext function handle_multilingual_email(email,
source_lang, user_lang): translated_to_source =
translate(email, source_lang) translated_to_user =
translate(translated_to_source, user_lang)
store_translation(email, translated_to_user)

A function called handle_multilingual_email that manages the user email 102 translation through several steps. The function takes three parameters: the user email 102, the source language, and the user 110 preferred language. It first calls translate to convert the user email 102 into the source language, storing the result in translated_to_source. The function then calls translate again to convert from the source language to the user's 110 preferred language, storing this in translated_to_user. Finally, it calls store_translation to save both the original user email 102 and its final translation.

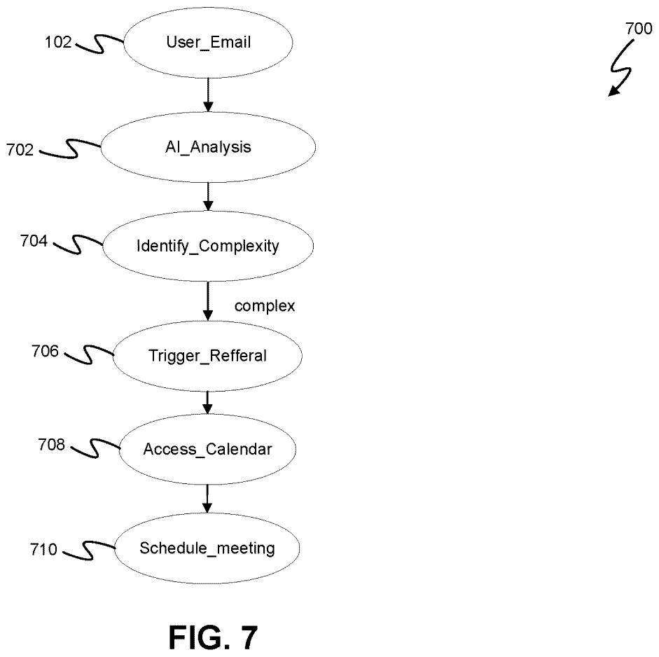

FIG. 7 depicts an automatic human referral system 700, which is an embodiment of an automatic personalized response generation process 200.

The process starts when an incoming user email 102 enters the automatic human referral system 700. The automatic human referral system 700 first moves the user email 102 to AI analysis 702, where it evaluates the content and context of the message. The flow then proceeds to identify complexity 704, where it determines if the inquiry requires human involvement. When the system identifies a “Complex” 706 case, it moves to trigger referral 708 to initiate the escalation process. The flow then advances to access calendar 710, where it checks available time slots. Finally, the process concludes at schedule meeting 712, where it arranges a meeting between the user 110 and the customer service providers.

### Pseudocode:

plaintext function handle_complex_inquiry(email):
complexity = analyze_complexity(email) if complexity >
threshold: schedule_meeting(email)

A function called handle_complex_inquiry that manages the escalation of complex email inquiries. The function begins by calling analyze_complexity to evaluate the incoming user email 102 and assign it a complexity score. It then compares this complexity score against a predefined threshold. If the complexity exceeds the threshold, the function calls schedule_meeting to automatically arrange a meeting for handling the inquiry. The code implements a straightforward decision process that determines when human intervention is needed.

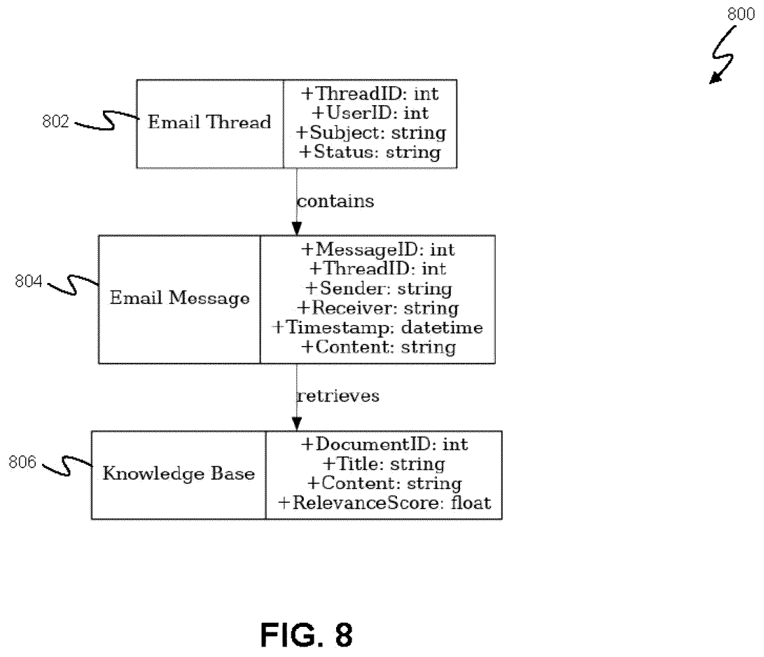

FIG. 8 depicts a data structure 800 for an automatic personalized response generation process 200.

The data structure contains: an email thread 802, an email message 804, which is also mentioned as the user email 102, and a knowledge base 806, which is also known as the knowledge database 114.

The email thread 802 includes a thread ID in int format, a user ID in int format, a subject in string format, and a status in string format. The email messages which is also mentioned as the user email 102 include Message ID in int format, Thread ID in int format, Sender in string format, receiver in string format, timestamp in data time format, and content in string format. The knowledge base includes a document ID in int format, Title in string format, content in string format, and relevance in float format.

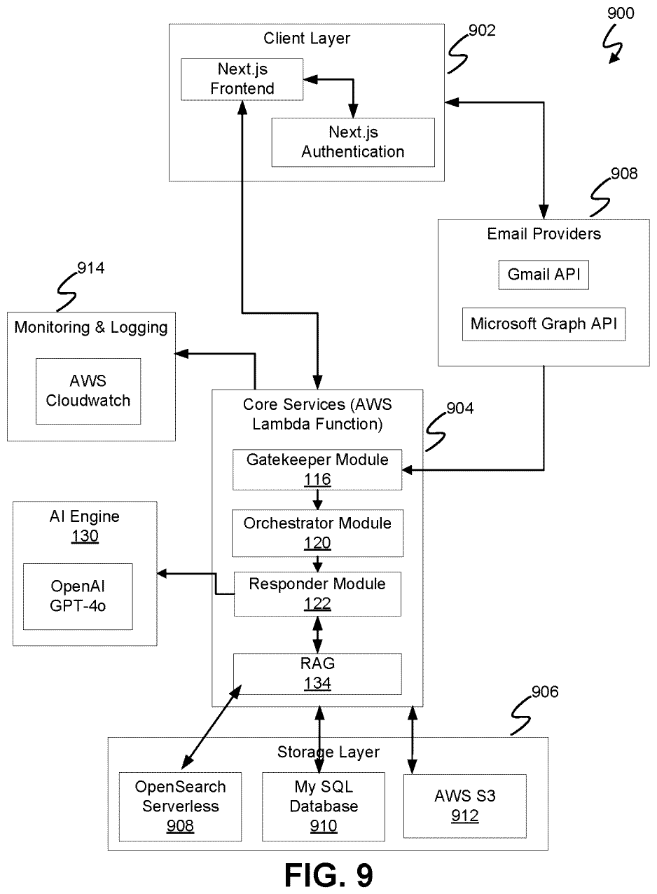

FIG. 9 depicts an architectural diagram 900 of an automatic personalized response generation process 200 utilized by the automatic personalized response generation system 100.

The automatic personalized response generation system 100 consists of three main layers: a client layer 902, a core service layer 904, and a storage layer 906.

In the client layer 902, the online platform 104 with NextAuth.js authenticates user 110 interactions and security. This frontend connects to email providers 908, such as Gmail API and Microsoft Graph API, to access the email services via the user email 102.

The core services layer 904 is powered by AWS Lambda Functions. The flow begins with the gatekeeper module 116 that classifies the user email 102. The gatekeeper module 116 passes control to the orchestrator module 120 through the knowledge module 118, which coordinates the automatic personalized response generation system 100 various components. The orchestrator module 120 then works with the responder module 122 that processes the personalized responses. The responder module 122 in at least one embodiment interacts with an RAG 134 for information retrieval and generation. The core services layer 904 incorporates AI engine 130 to enhance the processing of different modules in the core services layer 904.

The storage layer 906 utilizes three distinct storage solutions, such as OpenSearch Serverless 908, MySQL Database 910 and AWS S3 912, which provide object storage capabilities. The automatic personalized response generation system 100 monitors all operations through AWS CloudWatch 914 in a dedicated Monitoring & Logging section.

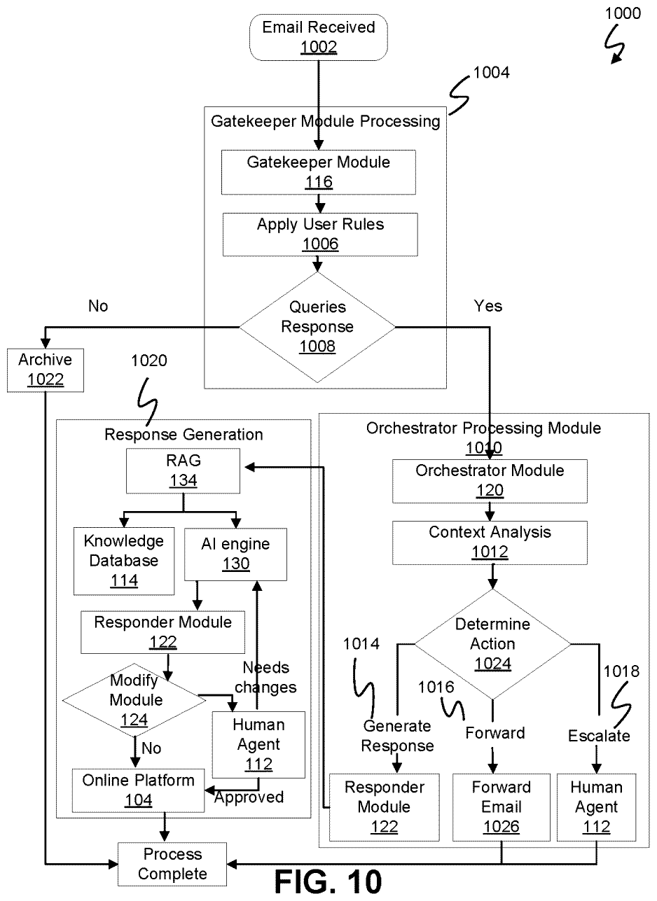

FIG. 10 depicts a process flow 1000 of an automatic personalized response generation process 200 utilized by the automatic personalized response generation system 100.

The process begins with an email reception 1002 via the email receiver 106. The gatekeeper module processes 1004 incoming user email 102. The gatekeeper module processes 1004 evaluates whether the user email 102 requires a response or not based on apply user rules via a diamond queries response 1008. If no response is needed, the gatekeeper module processes 1004 archives 1022 of the user email 102. If a response is required, the flow continues to the orchestrator module 120 processing stage.

In orchestrator module processing 1010 phase, the orchestrator module 120 performs context analysis 1012 of the user email 102 to determine the appropriate action. Based on the context analysis 1012 analysis, the orchestrator module processing 1010 by integrating determine action module 1024 directs the user email 102 down one of three paths: response generation 1014 via the responder module 122, forward email 1016, or escalate to team 1018 via the human agent 112. The selection depends on the complexity and requirements of the user email 102.

In at least one embodiment the response generation 1020 begins with the data from the RAG 134, which interacts with both the knowledge database 114 and the AI engine 130 to gather and store relevant information with evaluated user email. The responder module 122 generates the personalized response 1026 through the AI engine 130, then evaluates the personalized response through the modify module 124. The modify module 124 in at least one embodiment, sends the personalized response 1026 back through the AI engine 130 for refinement via a human agent 112. Once approved, the modify module 124 sends the personalized response 1026 to the online platform 104.

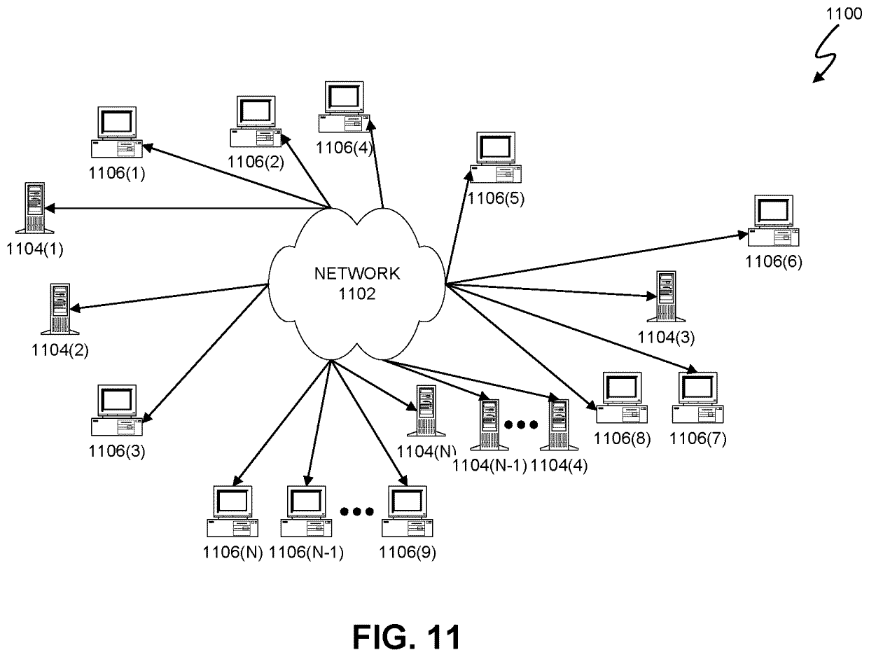

FIG. 11 is a block diagram illustrating a network environment in which an automatic personalized response generation system 100 and process 200 may be practiced. Network 1102 (e.g. a private wide area network (WAN) or the Internet) includes a number of networked server computer systems 1104(1)-(N) that are accessible by client computer systems 1106(1)-(N), where N is the number of server computer systems connected to the network. Communication between client computer systems 1106(1)-(N) and server computer systems 1104(1)-(N) typically occurs over a network, such as a public switched telephone network over asynchronous digital subscriber line (ADSL) telephone lines or high-bandwidth trunks, for example communications channels providing T1 or OC3 service. Client computer systems 1106(1)-(N) typically access server computer systems 1104(1)-(N) through a service provider, such as an internet service provider (“ISP”) by executing application specific software, commonly referred to as a browser, on one of client computer systems 1106(1)-(N).

Client computer systems 1106(1)-(N) and/or server computer systems 1104(1)-(N) are specialized computer programmed to improve conventional computer systems to implement and utilize the automatic personalized response generation system 100 and process 200. The type of computer system that can be specially programmed to implement and utilize the automatic personalized response generation system 100 and process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the automatic personalized response generation system 100 and process 200 can be implemented using code stored in a tangible, non-transient computer readable medium and executed by one or more processors. In at least one embodiment, the automatic personalized response generation system 100 and process 200 can be implemented completely in hardware using, for example, logic circuits and other circuits including field programmable gate arrays.

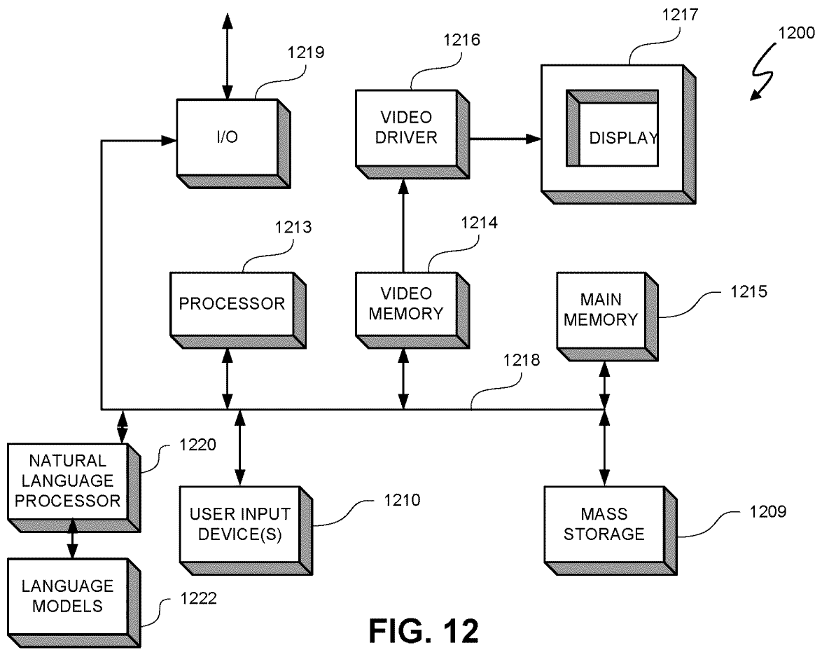

Embodiments of the automatic personalized response generation system 100 and process 200 can be implemented on a computer system such as a special-purpose, special-programmed computer 1200 illustrated in FIG. 12. Input user device(s) 1210, such as a keyboard and/or mouse, are coupled to a bi-directional system bus 1218. The input user device(s) 1210 are for introducing user input to the computer system and communicating that user input to processor 1213. The computer system of FIG. 12 generally also includes a non-transitory video memory 1214, non-transitory main memory 1215, and non-transitory mass storage 1209, all coupled to bi-directional system bus 1218 along with input user device(s) 1210 and processor 1213. The mass storage 1209 may include both fixed and removable media, such as a hard drive, one or more CDs or DVDs, solid state memory including flash memory, and other available mass storage technology. Bus 1218 may contain, for example, 32 of 64 address lines for addressing video memory 1214 or main memory 1215. The system bus 1218 also includes, for example, an n-bit data bus for transferring DATA between and among the components, such as CPU 1209, main memory 1215, video memory 1214 and mass storage 1209, where “n” is, for example, 32 or 64. Alternatively, multiplex data/address lines may be used instead of separate data and address lines.

I/O device(s) 1219 may provide connections to peripheral devices, such as a printer, and may also provide a direct connection to a remote server computer systems via a telephone link or to the Internet via an ISP. I/O device(s) 1219 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1209, into main memory 1215 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1213, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1215 is comprised of dynamic random access memory (DRAM). Video memory 1214 is a dual-ported video random access memory. One port of the video memory 1214 is coupled to video amplifier 1216. The video amplifier 1216 is used to drive the display 1217. Video amplifier 1216 is well known in the art and may be implemented by any suitable means. This circuitry converts pixel DATA stored in video memory 1214 to a raster signal suitable for use by display 1217. Display 1217 is a type of monitor suitable for displaying graphic images.

The computer system described above is for purposes of example only. The automatic personalized response generation system 100 and process 200 may be implemented in any type of computer system or programming or processing environment. It is contemplated that the automatic personalized response generation system 100 and process 200 might be run on a stand-alone computer system, such as the one described above. The automatic personalized response generation system 100 and process 200 might also be run from a server computer systems system that can be accessed by a plurality of client computer systems interconnected over an intranet network. Finally, the automatic personalized response generation system 100 and process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an artificial intelligence (AI) engine to automatically generate modified personalized responses for a user email comprising:
executing code using one or more processors of a computer system to cause the computer system to perform operations comprising:
receiving the user email form an online platform via an email receiver integrated within an email engine, wherein the user email includes questions and knowledge base articles;
classifying the user email using structured criteria via a gatekeeper module, wherein the gatekeeper module utilizes gatekeeper prompt for guiding the AI engine via a prompt generator to classify the user email;
gathering and structuring relevant information associated with the classified user email from a knowledge database via a knowledge module, wherein the knowledge module utilizes a knowledge prompt for guiding the AI engine via the prompt generator to gather and structure relevant information;
routing the classified user email and the relevant information via an orchestrator module, wherein the orchestrator module utilizes an orchestrator prompt for guiding the AI engine via the prompt generator to route the evaluated user email and the relevant information to a responder module or a human agent;
crafting personalized response via the responder module, wherein the responder module utilizes a responder prompt for guiding the AI engine via the prompt generator to craft the personalized response;
using a modify module to modify quality according to a quality criteria of the personalized responses, wherein the modify module utilizes a modify prompt for guiding the AI engine via the prompt generator to modify quality of personalized responses; and
using the email engine to transmit modified personalized responses to the user.

2. The method of claim 1 wherein the structured criteria classify the user email as human-generated, automated, or system-generated, determines an urgency level of the user email, and evaluates the user characteristics.

3. The method of claim 2 wherein identifying the user email as automated to trigger the gatekeeper module to archive the corresponding user email.

4. The method of claim 1 wherein the knowledge module retrieves data from the knowledge database using a retrieval-augmented generation (RAG) and provides the retrieved data to the AI engine.

5. The method of claim 1, wherein the orchestrator module further comprises:
analyzing the urgency of the user email;
determining a handler to evaluate escalation requirements;
verifying information sufficiency; and
establishing response timelines and resource requirements.

6. The method of claim 1, wherein the orchestrator module routes the user email and the relevant information to the human agent when: the user email requires urgent handling, the user email meets escalation criteria, the information is insufficient for automated processing, and/or the response timeline requires human intervention.

7. The method of claim 1, wherein an AI selection module analyzes the content of the user email, selects an AI model based on the analyzed content, and generates the email response using the selected AI model, wherein the AI model is integrated with the AI engine.

8. The method of claim 1 further comprises using a metrics module to categorize the user email and the personalized responses based on the predefined categorizes, wherein the metrics module utilizes a metrics incoming prompt and metrics outgoing prompt for guiding the AI engine to categorize the user email and personalized email responses.

9. The method of claim 1 wherein the knowledge database stores the questions and the knowledge base articles.

10. The method of claim 1 wherein the modified personalized responses is verified by the human agent before transferring to the user.

11. The method of claim 1 wherein the AI engine, guided by a translator prompt, selects a language option based on detected language characteristics in the user email, converts any modified personalized responses to the detected language, and maintains this language preference for future email communications with the user.

12. A system for guiding an artificial intelligence (AI) engine to automatically generate modified personalized responses for a user email comprising:
one or more processors of a computer system; and
a memory, coupled to the one or more processors, that stores code and execution of the code by the one or more processors causes the computer system to perform operations comprising:
receiving the user email form an online platform via an email receiver integrated within an email engine, wherein the user email includes questions and knowledge base articles;
classifying the user email using structured criteria via a gatekeeper module, wherein the gatekeeper module utilizes gatekeeper prompt for guiding the AI engine via a prompt generator to classify the user email;
gathering and structuring relevant information associated with the classified user email from a knowledge database via a knowledge module, wherein the knowledge module utilizes a knowledge prompt for guiding the AI engine via the prompt generator to gather and structure relevant information;
routing the classified user email and the relevant information via an orchestrator module, wherein the orchestrator module utilizes an orchestrator prompt for guiding the AI engine via the prompt generator to route the evaluated user email and the relevant information to a responder module or a human agent;
crafting personalized response via the responder module, wherein the responder module utilizes a responder prompt for guiding the AI engine via the prompt generator to craft the personalized response;
using a modify module to modify quality according to a quality criteria of the personalized responses, wherein the modify module utilizes a modify prompt for guiding the AI engine via the prompt generator to modify quality of personalized responses; and
using the email engine to transmit modified personalized responses to the user.

13. The system of claim 12 wherein the structured criteria classify the user email as human-generated, automated, or system-generated, determines an urgency level of the user email, and evaluates the user characteristics.

14. The system of claim 13 wherein identifying the user email as automated to trigger the gatekeeper module to archive the corresponding user email.

15. The system of claim 12 wherein the knowledge module retrieves data from the knowledge database using a retrieval-augmented generation (RAG) and provides the retrieved data to the AI engine.

16. The system of claim 12, wherein execution of the code by the one or more processors causes the orchestrator module to perform further operations comprising:
analyzing the urgency of the user email, determining a handler to evaluate escalation requirements, verifying information sufficiency, and establishing response timelines and resource requirements.

17. The system of claim 12, wherein the orchestrator module routes the user email and the relevant information to the human agent when: the user email requires urgent handling, the user email meets escalation criteria, the information is insufficient for automated processing, and/or the response timeline requires human intervention.

18. The system of claim 12, wherein an AI selection module analyzes the content of the user email, selects an AI model based on the analyzed content, and generates the email response using the selected AI model, wherein the AI model is integrated with the AI engine.

19. The system of claim 12 wherein execution of the code by the one or more processors causes the computer system to perform further operations comprising:
using a metrics module to categorize the user email and the personalized responses based on the predefined categorizes, wherein the metrics module utilizes a metrics incoming prompt and metrics outgoing prompt for guiding the AI engine to categorize the user email and personalized email responses.

20. The system of claim 12 wherein the knowledge database stores the questions and the knowledge base articles.

21. The system of claim 12 wherein the modified personalized responses is verified by the human agent before transferring to the user.

22. The system of claim 12 wherein the AI engine, guided by a translator prompt, selects a language option based on detected language characteristics in the user email, converts any modified personalized responses to the detected language, and maintains this language preference for future email communications with the user.
